(19) United States
(12) Patent Application Publication
(10) Pub. No.: US 2026/0289330 A1
(43) Pub. Date: Sep. 24, 2026

(54) SYSTEM

(71) Applicant: SoftBank Group Corp., Tokyo (JP)

(72) Inventor: Kotaro HOSOYAMADA, Tokyo (JP)

(73) Assignee: SoftBank Group Corp., Tokyo (JP)

(21) Appl. No.: 19/567,366

(22) Filed: Mar. 16, 2026

(30) Foreign Application Priority Data
Mar. 19, 2025 (JP) 2025-045170

(51) Int. Cl. G06N 5/01; G06F 40/166; G06F 40/284; G06F 40/30; G06F 40/40; G06N 3/0475

(52) U.S. Cl. CPC G06N 5/01; G06F 40/166; G06F 40/284; G06F 40/30; G06F 40/40; G06N 3/0475

(57) ABSTRACT

A system includes a processor that is configured to preprocess information acquired from a plurality of information sources and analyze the preprocessed information by using a machine learning algorithm, analyze a question of a user by using a natural language processing technique, input a prompt to a generative AI model to instruct the generative AI model to generate an appropriate answer to the question, and analyze a text input of the user by using a sentiment analysis algorithm and adjust the generated answer based on an emotion estimated from the text input.

### CROSS-REFERENCE TO RELATED APPLICATION

This application is based on and claims priority under 35 USC 119 from Japanese Patent Application No. 2025-045170 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional question-answering systems and chatbot systems that utilize machine learning and natural language processing often suffer from several limitations. First, such systems typically rely on static or infrequently updated models that are trained on pre-collected information sources, and therefore cannot adequately adapt to changes in user behavior, new information, or evolving usage contexts. Second, many existing systems do not fully integrate sentiment analysis into the answer generation process, resulting in responses that are technically correct but insensitive to the emotional state of the user, which can degrade user satisfaction and trust. Third, although some systems may log usage data, they generally do not employ a structured feedback loop to improve the underlying models based on actual user interactions, nor do they dynamically adjust usage benefits or incentives in response to the user's emotional state in real time. Accordingly, there is a need for a system that can (i) preprocess and learn from information acquired from multiple information sources, (ii) generate appropriate answers via a generative AI model based on natural language processing of user questions, (iii) incorporate sentiment analysis to adjust responses according to the user's emotional state, and (iv) collect and utilize usage data and emotional context to continuously evolve the models and dynamically control usage benefits to be provided to the user.

### SUMMARY

In order to solve the above problems, a system is provided that comprises a processor configured to preprocess information acquired from a plurality of information sources and analyze the preprocessed information by using a machine learning algorithm, to analyze a question of a user by using a natural language processing technique, and to input a prompt to a generative AI model to instruct the generative AI model to generate an appropriate answer to the question. The processor is further configured to analyze a text input of the user by using a sentiment analysis algorithm and to adjust the generated answer based on an emotion estimated from the text input, thereby enabling the system to provide emotionally adaptive responses. In addition, the processor is configured to collect usage data of the user and to update a model through a feedback loop so that the system evolves over time in accordance with accumulated interaction history. Furthermore, the processor is configured to monitor an emotional state of the user in real time and to dynamically adjust content or an amount of a usage benefit to be provided according to the emotional state, thereby enabling personalized incentive control that reflects both behavioral and emotional aspects of the user.

The term “processor” refers to one or more hardware processing units, such as a central processing unit (CPU), a graphics processing unit (GPU), a digital signal processor (DSP), or any combination thereof, that execute instructions to implement the functions described in the claims.

The term “information source” refers to any origin of data or content, including but not limited to websites, databases, documents, logs, or external application programming interfaces (APIs), from which information is acquired for preprocessing and analysis.
The term “preprocess” refers to performing one or more operations on raw information, such as cleaning, normalization, tokenization, removal of stopwords, stemming, lemmatization, or formatting, so as to convert the raw information into a form suitable for analysis by a machine learning algorithm.
The term “machine learning algorithm” refers to any algorithm or model that is configured to learn patterns or relationships from data, including supervised learning, unsupervised learning, semi-supervised learning, and reinforcement learning methods, such as neural networks, decision trees, support vector machines, clustering algorithms, or probabilistic models.
The term “natural language processing technique” refers to any computational technique for analyzing or processing human language text, including but not limited to syntactic parsing, morphological analysis, semantic analysis, intent detection, entity recognition, and text classification.
The term “generative AI model” refers to any artificial intelligence model that is capable of generating new content, such as text, based on an input, including but not limited to large language models, transformer-based models, generative adversarial networks (GANs) adapted for text, or variational autoencoders used for natural language generation.
The term “prompt” refers to an input text or structured instruction provided to the generative AI model, which specifies or constrains the task to be performed by the generative AI model and guides the generation of an answer or other output.
The term “appropriate answer” refers to an output generated by the generative AI model that is relevant to the user's question, consistent with the information acquired from the plurality of information sources, and suitable in terms of content for the intended user context.
The term “text input of the user” refers to any character-based input provided by the user to the system, including but not limited to questions, comments, feedback, or conversational messages entered via a terminal.
The term “sentiment analysis algorithm” refers to an algorithm configured to estimate an emotional state, attitude, or polarity (for example, positive, negative, or neutral) from text, based on lexical, syntactic, semantic, or learned features.
The term “emotion estimated from the text input” refers to a representation of an emotional state, such as happiness, anger, frustration, satisfaction, or neutrality, inferred by the sentiment analysis algorithm from the user's text input.
The term “adjust the generated answer” refers to modifying at least part of the content, tone, style, length, or presentation of the answer generated by the generative AI model, based on the estimated emotion or other analysis results, before the answer is provided to the user.
The term “usage data of the user” refers to data that represent how the user interacts with the system, including but not limited to the frequency of use, types of questions asked, response selections, feedback, session durations, and timestamps.
The term “feedback loop” refers to a process wherein the system collects usage data and other interaction outcomes and uses the collected data to retrain, fine-tune, or otherwise update one or more models so that future behavior of the system reflects past interactions.
The term “evolves over time” refers to the capability of the system to change or improve its behavior, accuracy, or response quality by updating models or parameters based on accumulated data and feedback during operation.
The term “emotional state of the user” refers to a current or recent affective condition of the user, such as being satisfied, dissatisfied, stressed, calm, excited, or bored, as inferred from the user's text inputs or other signals.
The term “monitor in real time” refers to continuously or periodically analyzing incoming user inputs during an ongoing interaction session, with latency low enough that the analysis results can influence responses or benefits within the same session.
The term “usage benefit” refers to any advantage or incentive provided to the user based on the user's interaction with the system, including but not limited to discounts, credits, loyalty points, access to premium features, or other tangible or intangible rewards.
The term “content or an amount of a usage benefit” refers to the qualitative type (for example, discount vs. points) and the quantitative level (for example, percentage, monetary value, or number of points) of the usage benefit that is provided to the user.
The term “dynamically adjust” refers to changing, during system operation and without manual offline reconfiguration, one or more parameters or conditions, such as the content or the amount of a usage benefit, in response to changing inputs, states, or analysis results, including the emotional state of the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

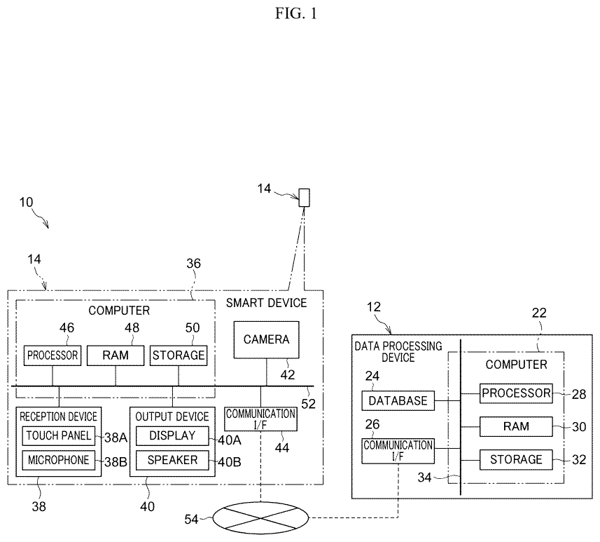

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

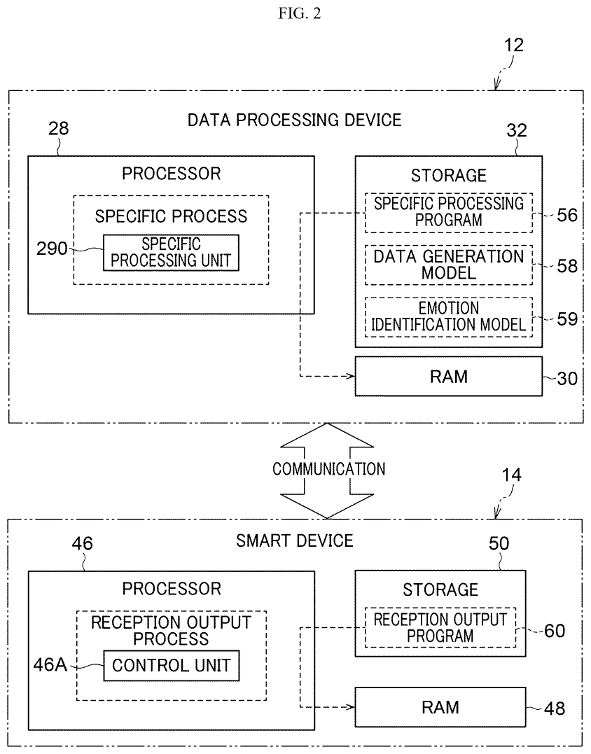

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional information processing systems that utilize machine learning and natural language processing, there are several technical limitations that impair the efficiency, accuracy, and adaptability of automated response generation. First, many systems treat text preprocessing, feature extraction, classification, and response generation as isolated components, without a unified pipeline that maintains consistency of representations between training and inference. This often leads to degraded model performance, inconsistent outputs, and increased computational overhead when integrating different subsystems.

Second, conventional architectures typically do not optimize the allocation of processing tasks between user-side terminals and server-side apparatuses. As a result, servers are frequently burdened with both computationally light but voluminous preprocessing tasks and computationally heavy model training and inference tasks. This allocation can lead to unnecessary network traffic, increased latency, and inefficient use of computing resources, particularly when large volumes of raw text data are transmitted without prior reduction or structuring on the user side.
Third, many existing systems rely solely on statistical or rule-based classifiers, or solely on generative AI models, without tightly coupling discriminative classification outputs with generative response mechanisms. In such systems, the generative model may not be constrained or guided by the results of upstream classification, which can cause responses to be poorly targeted, overly generic, or misaligned with the underlying content categories of the input information. This undermines the technical effectiveness of the generative model in tasks such as topic-specific assistance, domain-aware dialogue, and context-sensitive explanation.
Fourth, conventional automated response systems rarely integrate real-time emotion estimation of user input into the core control flow of response generation. Even when sentiment analysis is present, it is often used only for logging or coarse post-processing, rather than for dynamically controlling the instruction structure, output format, level of detail, or tone provided as a prompt sentence to a generative AI model. Consequently, the system cannot adapt the style and granularity of responses to different emotional states of users, leading to suboptimal user interaction quality and repeated clarification exchanges that increase computational load and network usage.
Fifth, typical systems do not maintain an effective feedback loop that leverages user usage history and estimated emotional states to update both classification models and prompting strategies for generative models. Without such a feedback mechanism, classification accuracy and prompt design remain static, and the system cannot systematically evolve to better match real usage patterns. This lack of adaptivity results in increased need for manual tuning, higher maintenance costs, and reduced robustness when the distribution of input data or user behavior changes over time.
Accordingly, there is a need for an improved computer-implemented system and method that (i) unifies text preprocessing, feature vector generation, supervised classification, and generative response control in a consistent pipeline; (ii) optimizes the distribution of processing between user-side terminals and server-side apparatuses; (iii) tightly couples classification outputs with generative AI models through structured prompt sentences; (iv) dynamically adjusts prompt construction based on estimated emotional states; and (v) updates both classification models and prompt construction strategies using feedback derived from user usage history and emotional information. Such improvements would enhance the technical functioning of the information processing system itself, including resource utilization, latency, robustness, and response relevance.

The specific processing by the specific processing unit 290 of the data processing device 12 in Example 1 is realized by the following means.

The present invention provides a server comprising a processor configured to receive character information obtained from a plurality of information sources, apply preprocessing including character normalization and removal of unnecessary symbols and numerals, segment the preprocessed character information into lexical units, perform decomposition including removal of function words and conversion of the lexical units into stems, convert the lexical units into numerical representations based on statistical feature quantities, generate a classification estimation model using a supervised learning scheme based on the numerical representations and associated classification information, estimate classification information for new character information using the classification estimation model, construct an instruction sentence as a prompt sentence for input to a generative AI model based on a question sentence received from a user and the estimated classification information, input the instruction sentence to the generative AI model to cause generation of a response sentence, analyze character input from the user using an emotion estimation scheme to estimate an emotional state, adjust expression content of the response sentence and at least one of an output format, a level of detail, and a tone specified in the instruction sentence according to the emotional state, and collect usage history information of the user and update at least one of the classification estimation model and a method for constructing the instruction sentence based on the usage history information and the emotional state. This enables an integrated technical architecture in which preprocessing and feature generation are consistently aligned between training and inference, in which classification results and emotional state estimates directly control structured prompts to the generative AI model, and in which server-side computation, network usage, and model behavior are adaptively optimized over time to improve the performance, efficiency, and responsiveness of the computer system itself.

The term “character information” refers to information expressed as a sequence of characters, including letters, symbols, numerals, and punctuation, obtained from one or more digital data sources.

The term “information source” refers to any data-providing system or storage, including network-accessible services, databases, repositories, and content servers, from which character information can be acquired.
The term “preprocessing” refers to a sequence of operations for transforming raw character information into a normalized and cleaned form suitable for computational analysis, including at least character normalization and removal of unnecessary symbols and numerals.
The term “character normalization” refers to processing that converts characters into a standardized representation, such as unifying character sets, cases, encodings, or variants, so that semantically equivalent characters are represented uniformly.
The term “unnecessary symbols and numerals” refers to characters, punctuation, or numeric values that are determined, according to predefined rules, to be non-contributory or detrimental to subsequent analysis, and that are therefore removed during preprocessing.
The term “lexical unit” refers to a minimal segment of text obtained by segmenting preprocessed character information, including words, terms, or equivalent tokenized elements used for further linguistic or statistical processing.
The term “decomposition processing” refers to processing that transforms lexical units into simpler or more abstract representations, including removal of function words and conversion of lexical units into stems.
The term “function word” refers to a word that primarily serves a grammatical role rather than conveying substantial semantic content, such as articles, conjunctions, pronouns, and prepositions, and that may be removed to emphasize content-bearing words.
The term “stem” refers to a base or root form of a lexical unit obtained by algorithmic reduction, such that related inflected or derived forms of a word are mapped to a common representation.
The term “statistical feature quantity” refers to a numerical measure derived from analysis of text data, including frequencies, term weights, co-occurrence measures, or other statistics used to characterize lexical units.
The term “numerical representation” refers to a vector, matrix, or other numerical structure that encodes lexical units or documents as feature values based on statistical feature quantities, for use in machine learning or similar computational methods.
The term “classification information” refers to label information or category identifiers associated with character information, indicating a class, topic, type, or other discrete category assigned to the character information.
The term “classification estimation model” refers to a computational model trained using supervised learning that receives numerical representations as input and outputs classification information for corresponding character information.
The term “supervised learning scheme” refers to a machine learning method in which a model is trained on pairs of input data and known target labels, such that the model learns to predict labels for previously unseen input data.
The term “new character information” refers to character information that was not included in training data for the classification estimation model and that is subjected to classification or analysis during inference.
The term “question sentence” refers to a sentence or sequence of sentences provided by a user, expressed in natural language, that requests information, explanation, classification, or another operation from the system.
The term “instruction sentence” refers to a text string constructed by the system that specifies to a generative AI model how to process given content, including constraints, requested output format, level of detail, or tone.
The term “prompt sentence” refers to an instruction sentence or equivalent input text provided to a generative AI model to cause the generative AI model to generate a corresponding output.
The term “generative AI model” refers to a machine learning model configured to generate new text or other data based on input text, including but not limited to large language models that produce natural-language responses token by token.
The term “response sentence” refers to text generated by the generative AI model in response to an instruction sentence or prompt sentence and intended to be presented to a user.
The term “emotion estimation scheme” refers to a computational method or algorithm that analyzes user input, such as character input, to infer an emotional state, including but not limited to sentiment polarity or specific affective categories.
The term “emotional state” refers to an inferred condition of a user's affective status, such as positive, neutral, negative, or more granular emotional categories, estimated from user input by the emotion estimation scheme.
The term “expression content of the response sentence” refers to linguistic aspects of a response sentence, including wording, phrasing, politeness, emphasis, or style, which may be adjusted in accordance with the emotional state.
The term “output format” refers to a structural specification for a generated response, including but not limited to list form, paragraph form, bullet points, headings, or other layout and organization characteristics.
The term “level of detail” refers to a degree of granularity in a generated response, including the amount of explanation, number of examples, or depth of reasoning included in the response.
The term “tone” refers to a stylistic characteristic of a generated response, including but not limited to formality, politeness, empathy, directness, or other manner of expression.
The term “usage history information” refers to data representing past interactions of a user with the system, including but not limited to issued question sentences, received responses, response selections, corrections, feedback, timestamps, and interaction frequencies.
The term “method for constructing the instruction sentence” refers to rules, templates, algorithms, or parameter settings used to assemble an instruction sentence from available information, including question sentences, classification information, and emotional states.
The term “information processing terminal” refers to a computing device used by or located near a user, including but not limited to a personal computer, mobile device, or other client device capable of executing preprocessing or interaction functions.
The term “information processing apparatus” refers to a server-side or network-connected computing system that executes one or more processing tasks, including model training, inference, and response generation, and that communicates with an information processing terminal.
The term “communication network” refers to any wired or wireless network infrastructure, including local networks and wide-area networks, over which data is exchanged between an information processing terminal and an information processing apparatus.

In one embodiment, a server executes a computer program that implements the system described in the claims. The server includes at least one central processing unit (CPU), a main memory, a non-volatile storage device, and a network interface. The server executes an operating system such as a general-purpose server operating system and runs application software including a text preprocessing module, a feature extraction module, a classification training/inference module, a generative AI interface module, an emotion estimation module, and a usage-history management module. The server communicates with one or more terminals operated by users through a communication network such as the Internet.

A terminal includes a processor, a memory, a storage device, a display, and input devices such as a keyboard and a pointing device, or touch input hardware in the case of a mobile device. The terminal executes a client application or web browser that provides a user interface for entering a question sentence, viewing a response sentence, and optionally performing local preprocessing. The user operates the terminal to obtain character information from various information sources and to submit prompt sentences and other input text to the server.
The server is configured to receive character information acquired from a plurality of information sources. The user can acquire the character information by using application programming interfaces provided by network-based services, or by downloading documents from content storage systems. The terminal may send the acquired character information to the server in a structured format such as a collection of documents, where each document is represented as a sequence of characters. The server stores the received character information in a persistent storage device, for example as records in a database or as entries in a file-based store.
The server performs preprocessing on the stored character information. The server converts the character information to a normalized form by, for example, converting all letters to a single case, unifying character encodings, and mapping visually similar characters to a canonical representation. The server removes unnecessary symbols and numerals according to predefined rules. For example, the server discards characters that match regular expression patterns corresponding to punctuation, control characters, and isolated numerals that are not part of domain-specific identifiers. The server applies these rules deterministically so that the same raw input always yields the same normalized output. By reducing the character set and eliminating noise, the server reduces the dimensionality of downstream feature spaces and improves the numerical stability of subsequent computation.
In some embodiments, the terminal executes part or all of the preprocessing. The terminal runs a general-purpose programming language runtime and applies character normalization and symbol removal rules to raw text before transmitting the processed text to the server. As a result, the size of data transmitted from the terminal to the server is reduced. This reduction in payload size lowers network bandwidth consumption and decreases end-to-end latency. The server then continues processing from a later stage in the pipeline, thereby offloading part of the processing burden from the server to the terminal.
The server or the terminal segments the preprocessed character information into lexical units. The server executes a tokenization module that splits text into words based on whitespace, punctuation, and language-specific patterns. The server identifies lexical units as tokens such as words, numbers, and symbols that remain after preprocessing. The server filters out tokens that are not useful for semantic analysis, for example, very short tokens or tokens composed only of punctuation. The result is a deterministic list of lexical units for each document, which serves as the basis for further linguistic and statistical processing.

The server performs decomposition processing on the lexical units. The server removes function words by comparing each lexical unit against a stored list of common function words for the relevant language. The server stores such lists in the storage device and loads them into memory at runtime. The server then converts remaining lexical units into stems using a stemming algorithm. The server applies a rule-based stemmer that reduces inflected forms to base forms through a series of suffix-stripping and pattern-matching operations. By mapping multiple surface forms to a single stem, the server reduces feature sparsity and increases the density of the feature space, which improves generalization capabilities of the classifier and reduces memory usage for model parameters.

The server converts lexical units into numerical representations based on statistical feature quantities. The server maintains a vocabulary data structure that maps each distinct lexical unit or stem to an integer index. The server computes term frequency values for each vocabulary term in each document and computes inverse document frequency values across the corpus. The server multiplies these quantities to obtain term-weight values for each term-document pair. The server stores these values in a sparse matrix representation. This matrix serves as a numerical representation of the corpus in which each dimension corresponds to a particular lexical feature. Because the representation is sparse and compressed, the server can process large corpora with reduced memory footprint and improved cache locality, which accelerates linear algebra operations during model training and inference.
The server generates a classification estimation model using a supervised learning scheme. The server maintains training data in which each document's numerical representation is associated with classification information, such as a category label. The server loads the numerical representations and corresponding labels into memory and executes a training algorithm such as a support vector classifier or a logistic regression classifier. The server selects hyperparameters such as regularization strength and kernel type, and applies an optimization algorithm such as stochastic gradient descent or a quadratic programming method to minimize a loss function defined over the training set. The server updates the classifier's internal parameter vectors during training and stores the learned parameters in the storage device. The server thereby constructs a classification estimation model that maps numerical representations to classification information.
In some embodiments, the server generates a neural network-based classification estimation model. The server initializes a multi-layer neural network with an input layer sized to the dimensionality of the numerical feature space, one or more hidden layers with activation functions such as rectified linear units, and an output layer with one unit per class and a softmax activation. The server selects a loss function such as cross-entropy and an optimizer such as Adam. The server iteratively computes forward passes through the network to obtain predictions, computes the loss, and then computes gradients of the loss with respect to network weights using backpropagation. The server updates the weights based on the gradients and learning-rate parameters. This neural network model can capture nonlinear relationships between lexical features and classes, improving classification accuracy in complex domains. By storing and reusing the trained neural network, the server reduces the need for repeated training, which conserves computational resources.
When the server receives new character information for inference, the server applies the same preprocessing, segmentation, decomposition, and numerical conversion procedures to the new character information, using the same rules and vocabulary as in training. This consistency guarantees that the numerical representation for the new character information is compatible with the classification estimation model. The server then applies the classification estimation model to the numerical representation to estimate classification information for the new character information. Because the same vocabulary and feature scaling are used, the classifier's decision boundaries remain valid, which reduces misclassification errors and avoids model drift.
The server is further configured to construct an instruction sentence as a prompt sentence for input to a generative AI model. The user provides a question sentence via the terminal, and the terminal transmits the question sentence to the server. The server retrieves the classification information estimated for the relevant character information and composes an instruction sentence that includes at least the question sentence, the classification information, and one or more control directives specifying output format, level of detail, or tone. The server may use templates or rule-based logic to construct the instruction sentence, for example by inserting the estimated category into a fixed pattern and appending instructions such as “explain your reasoning” or “use concise bullet points.” By explicitly encoding classification information and response constraints in the prompt sentence, the server guides the generative AI model toward more relevant and structured output, which reduces the need for post-processing and follow-up clarification.
The server interacts with a generative AI model that is deployed either locally on the server or on an external processing apparatus accessible via the communication network. The generative AI model may be a large language model implemented as a multi-layer transformer network with self-attention mechanisms. The server provides the constructed instruction sentence and any relevant context as input tokens to the generative AI model. The model computes internal representations using matrix multiplications and attention-weighted combinations of token embeddings across multiple layers. The server controls generation parameters such as maximum output length, temperature, and sampling strategy. By adjusting these parameters based on classification information and emotional state, the server controls the trade-off between determinism, diversity, and specificity in the generated response.
The server also performs emotion estimation on character input from the user. The server maintains an emotion estimation model, which can be a classifier trained on labeled data indicating user sentiment or emotional categories. The server converts the user's character input into numerical representations using a similar feature extraction pipeline. The server then applies the emotion estimation model to infer an emotional state such as positive, neutral, or negative, or more granular categories. The server stores the estimated emotional state in association with the corresponding interaction in a usage-history data store. The server uses the emotional state to modify the instruction sentence, for example by inserting directives such as “respond empathetically” when a negative emotional state is detected or “provide more detailed technical explanation” when a user appears frustrated or confused. This dynamic adjustment improves the alignment between system responses and user needs, which can reduce repeated interactions and conserve processing and network resources.
The server collects usage history information for each user or for sessions. The server stores data such as past question sentences, classification results, emotional states, and user reactions such as follow-up questions. The server periodically analyzes this usage history to update the classification estimation model, for example by retraining the model with additional labeled data derived from user interactions or by adjusting model hyperparameters in response to performance metrics. The server also updates methods for constructing instruction sentences, refining templates or rule sets based on observed success or failure of prior prompts. By continuously adjusting models and prompt design using this feedback loop, the server maintains high classification accuracy and response relevance even when input distributions or user expectations change over time.
The terminal provides a user interface for inputting prompt sentences and viewing response sentences. For example, the terminal displays an input field where the user can enter a prompt such as:
“Please classify the following news article into politics, economy, or sports, and then explain your reasoning in 3-4 sentences. Article: [full article text].”
Another example prompt sentence is:
“Based on this article, describe the main economic risks and opportunities, and provide two recommendations for an investor. Article: [full article text].”
A further example prompt sentence is:
“Classify this news article into one of the following categories: politics, economy, or sports. Output only the category name. Article: [full article text].”
The terminal transmits these prompt sentences and associated article text to the server via the communication network. When the server returns a response sentence and additional metadata such as the estimated category and emotional state, the terminal displays the information in a structured layout. The terminal may highlight the predicted category, show a confidence score, and present the generated explanation or advice in a clearly separated area.

The described architecture provides technical improvements beyond mere automation of human tasks. By distributing preprocessing between the terminal and the server, the system reduces data volume transmitted over the network, which directly lowers communication load and latency. By enforcing consistent preprocessing and feature extraction on both training and inference data, the server reduces model errors caused by feature mismatch, improving classification accuracy. By using a sparse numerical representation optimized for matrix operations, the server exploits hardware-level parallelism in the CPU and optionally in a graphics processing unit, improving processing throughput and resource utilization. Moreover, the tight coupling between the classification estimation model and the generative AI model through structured instruction sentences results in a more efficient use of computational resources. Generative models are expensive to run; by constraining their behavior with classification-derived context and by dynamically adjusting output parameters, the server reduces unnecessary generation of irrelevant text. This leads to shorter response sentences when appropriate, decreased token generation, and fewer subsequent user queries, which collectively reduce processor usage and network traffic.

The emotion estimation and feedback mechanisms also contribute to technical improvements. By detecting user emotional states and adjusting the tone, level of detail, and format of responses, the server can reduce the number of iterations needed for the user to obtain satisfactory information. This reduction in back-and-forth interactions directly reduces load on both server and network. Furthermore, by using usage history data to retrain and reconfigure models automatically, the server maintains high performance without continuous human tuning, which is particularly important when operating large-scale, multi-user systems.
In another embodiment, the server uses alternative feature extraction methods, such as embedding representations computed by a neural network encoder. In this case, the server maps lexical units or entire sentences to dense vectors in a low-dimensional space. These dense vectors replace or augment sparse term-weight vectors, and the classification estimation model and emotion estimation model are adapted to operate on the dense feature space. Such configurations may further reduce memory and storage requirements and improve classification and emotion estimation accuracy.
In yet another embodiment, the architecture of the generative AI model can be varied. The server can interface with a model configured with different numbers of transformer layers, attention heads, and parameter counts. The server can dynamically select among multiple generative models depending on the classification information or complexity of the user's request, using smaller models for simple classification explanations and larger models for complex multi-document synthesis. This adaptive model selection further optimizes computation time and power consumption on the server-side apparatus.
The system thus provides a concrete arrangement of hardware and software components, including the server, the terminal, the text processing modules, the classification estimation model, the generative AI model, the emotion estimation module, and the usage-history manager. These components cooperate in a specific data flow and computational procedure that improves processing speed, accuracy, and efficiency of automated text analysis and response generation. The structure and operations of this system go beyond generic data collection and display and instead implement a specialized, technically grounded pipeline that improves the functioning of the computer system itself.

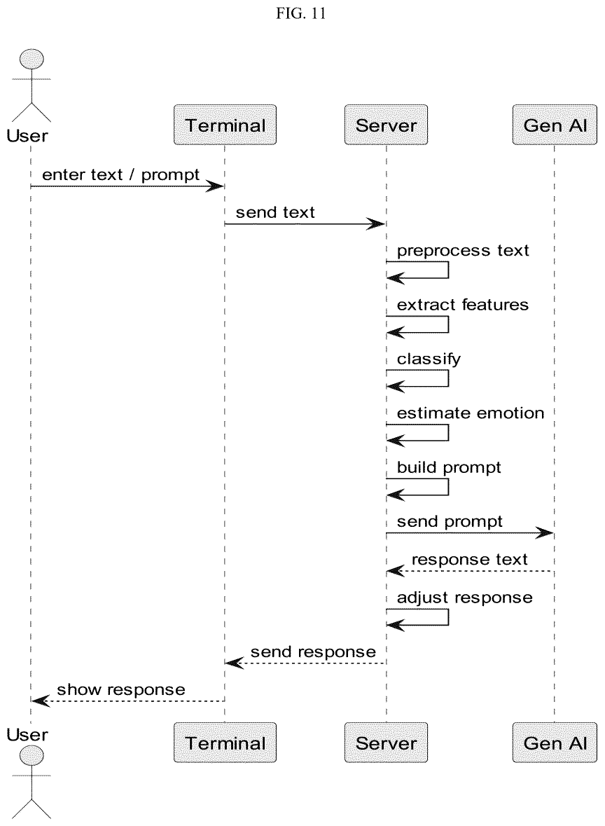

The following describes the processing flow using FIG. 11.

### Step 1:

User acquires character information from multiple information sources.
User uses a terminal to access network-based content providers such as information servers, databases, or content repositories and issues requests through an application or browser.
Input: Search conditions or URLs specified by the user.
Output: Raw character information such as article texts, posts, or messages.
User causes the terminal to retrieve the raw character information via network protocols and stores the retrieved texts in local memory or local storage.

### Step 2:

Terminal transmits character information to the server.
Terminal reads the locally stored character information, groups it into document units, and attaches metadata such as document identifiers and source types.
Input: Raw character information and associated metadata stored on the terminal.
Output: A structured payload containing a list of documents transmitted to the server.
Terminal establishes a network connection to the server and sends the payload using a communication protocol, for example via an HTTP-based request.

### Step 3:

Server performs preprocessing on the received character information.
Server receives the payload, parses the document list, and stores each document in server memory. Server converts all characters in each document to a normalized form, such as converting letters to a single case and unifying encodings. Server applies rules to remove unnecessary symbols and isolated numerals by scanning each character sequence and discarding characters that match predefined pattern sets.
Input: Raw character information and document metadata received from the terminal.
Output: Normalized and cleaned character information for each document.
Server writes the cleaned character information to an intermediate data store for use in later steps.

### Step 4:

Server segments the preprocessed character information into lexical units.
Server applies a tokenization routine that splits each cleaned document into tokens at whitespace boundaries and punctuation marks according to language-specific rules. Server removes tokens that contain only punctuation or whitespace and retains tokens that represent candidate lexical units.
Input: Cleaned character information for each document.
Output: For each document, a sequence (list) of lexical units.
Server stores the sequences of lexical units in memory in association with document identifiers.

### Step 5:

Server performs decomposition processing by removing function words and generating stems.
Server loads a function-word list from storage into memory and compares each lexical unit in the sequence against the list. Server discards lexical units that match entries in the function-word list. For remaining lexical units, server applies a stemming algorithm that reduces inflected forms to base stems by executing suffix-stripping rules and pattern-matching operations.
Input: Sequences of lexical units per document.
Output: For each document, a filtered sequence of stems representing content-bearing lexical units.
Server records the resulting sequences of stems in a data structure indexed by document identifiers.

### Step 6:

Server converts sequences of stems into numerical representations based on statistical feature quantities.
Server constructs or updates a vocabulary map that assigns an index to each distinct stem in the corpus. Server counts term frequencies for each stem per document and computes document frequencies across the corpus. Server calculates statistical feature quantities such as term-frequency-inverse-document-frequency weights. Server assembles these weights into a sparse matrix where rows correspond to documents and columns correspond to vocabulary indices.
Input: Sequences of stems for all documents.
Output: A sparse numerical feature matrix and an associated vocabulary map.
Server stores the feature matrix and vocabulary map in persistent storage for model training and later inference.

### Step 7:

Server trains a classification estimation model using supervised learning.
Server loads labeled training data, where each training document is associated with classification information such as a category. Server selects a learning algorithm, for example a linear support-vector classifier or a logistic regression classifier. Server feeds the corresponding rows of the feature matrix and the labels into the learning algorithm, computes gradients or optimization steps according to a loss function, and updates internal model parameters until convergence criteria are met.
Input: Numerical feature matrix for training documents and associated classification information.
Output: A trained classification estimation model with fixed parameter values.
Server saves the trained model in storage and registers the model for use in classification of new documents.

### Step 8:

User submits a question sentence and associated text via the terminal.
User operates the terminal interface to input a natural-language question sentence and to paste or select one or more documents that the user wants to be analyzed. User may, for example, request classification, explanation, or summarization of the text.
Input: User-entered question sentence and selected document text on the terminal.
Output: A structured request payload containing the question sentence and the document text sent to the server.
Terminal packages the question sentence and document text into request parameters and transmits them to the server using a network protocol.

### Step 9:

Server applies the preprocessing and feature extraction pipeline to the submitted document text.
Server extracts the document text from the request and processes it using the same normalization, cleaning, tokenization, function-word removal, and stemming procedures as applied during training. Server then uses the stored vocabulary map to convert stems into a numerical feature vector, computing term weights according to the previously defined statistics.
Input: Document text contained in the user's request.
Output: A numerical feature vector representing the submitted document in the feature space consistent with the trained model.
Server stores the feature vector in memory as the basis for classification.

### Step 10:

Server estimates classification information for the submitted document.
Server loads the trained classification estimation model from storage if it is not already in memory. Server applies the model to the feature vector by computing a decision function or probability distribution over possible classes using the model's learned parameters. Server selects the class with the highest score as the estimated classification information and may also compute confidence values.
Input: Numerical feature vector for the submitted document and the trained classification estimation model.
Output: Estimated classification information and optional confidence scores for the document.
Server associates the estimated classification information with the request context for use in prompt construction.

### Step 11:

Server estimates an emotional state from the user's character input.
Server extracts the user's question sentence and any additional user messages from the request, and converts these texts into numerical representations using an emotion-specific feature extraction pipeline that may reuse the same or similar preprocessing operations.
Server applies an emotion estimation model, such as a classifier trained on labeled emotional categories, to the numerical representation to obtain an estimated emotional state.
Input: User's question sentence and corresponding numerical representation.
Output: An estimated emotional state label and optional confidence values.
Server stores the estimated emotional state in association with the current interaction and appends it to a usage-history record.

### Step 12:

Server constructs an instruction sentence as a prompt sentence for a generative AI model.
Server analyzes the user's question sentence, the estimated classification information, and the estimated emotional state. Server applies rule-based logic or templates to assemble an instruction sentence that specifies both the task and the manner of response. For example, server may include the estimated category, request explicit reasoning, and set the desired tone or level of detail according to the emotional state.
Input: User's question sentence, estimated classification information, and estimated emotional state.
Output: A structured instruction sentence formatted as a prompt sentence for the generative AI model.
Server records the constructed prompt sentence for logging and potential later learning.

### Step 13:

Server generates a response sentence using the generative AI model.
Server sends the instruction sentence as input tokens to the generative AI model, which may be implemented as a multi-layer transformer network hosted locally or on an external computation node. Server controls generation parameters such as maximum token count and sampling temperature. The generative AI model processes the tokens across multiple layers of attention and feed-forward computations, producing output tokens one by one according to probability distributions computed from learned weights.
Input: Instruction sentence provided as a prompt sentence and associated generation parameters.
Output: A generated response sentence comprising a sequence of tokens converted back to characters.
Server collects the generated tokens, concatenates them into a character sequence, and stores the response sentence in memory.

### Step 14:

Server adjusts the response sentence based on the emotional state and desired output characteristics.
Server inspects the generated response sentence and evaluates whether its tone, level of detail, and format comply with constraints derived from the emotional state and classification information. Server may, for example, add clarifying sentences, shorten or expand sections, or insert polite or empathetic expressions to match the user's emotional state.
Input: Generated response sentence, estimated emotional state, and output format parameters.
Output: A finalized response sentence adjusted in content and style.
Server attaches metadata such as the estimated category, emotional state, and confidence scores to the finalized response for transmission.

### Step 15:

Server returns the finalized response and metadata to the terminal.
Server packages the response sentence and associated metadata into a response payload and sends it to the terminal via the established communication channel.
Input: Finalized response sentence and metadata stored on the server.
Output: A network response payload containing the response sentence and metadata delivered to the terminal.
Server records the interaction in a usage-history store, including question sentence, classification result, emotional state, and response characteristics.

### Step 16:

Terminal presents the response sentence and related information to the user.
Terminal receives the response payload, parses the response sentence, category label, and any additional data, and renders them in the user interface. Terminal may display the predicted category prominently and show the explanation or recommendations generated by the system in an appropriate layout.
Input: Response payload received from the server.
Output: Visual presentation of the response sentence and metadata on the terminal display.
User then reads the response, may copy or store the information, and may decide to issue a new prompt sentence based on the provided output.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information recommendation and question answering systems suffer from several technical limitations in how they process user inputs and large volumes of textual data. First, existing architectures typically separate content retrieval, user modeling, and response generation into loosely coupled modules that operate on heterogeneous data representations. As a result, such systems frequently incur redundant computations for text preprocessing and feature extraction, leading to increased processor load, memory usage, and latency in generating personalized results.

Second, many conventional systems are unable to effectively integrate user interest modeling with prompt generation for a generative AI model. In typical implementations, prompt sentences for a generative AI model are constructed as static templates or manually crafted rules that do not adapt to changing user behavior. This causes the generative AI model to receive suboptimal context and instructions, which degrades output quality and wastes computational resources of the model and the server.
Third, existing systems often treat user behavior logs (such as browsing history, interaction history, and evaluation information) and user emotional state as secondary signals that are either ignored or processed in batch analytics pipelines that are not tightly integrated with real-time response generation. Consequently, these systems cannot promptly adjust user-interest models or prompt sentences based on fine-grained behavior and emotional context. This results in technically inefficient use of models and network resources, since the same or similar responses may be produced repeatedly even when the user's interests or emotional state have shifted.
Fourth, many systems fail to couple user-emotion estimation with the control of generative AI outputs at the system level. In such systems, responses from a generative AI model are applied directly to user interfaces without systematic adjustment of expression style, content emphasis, or information volume based on a user's emotional state. This can lead to user disengagement, unnecessary network transmissions of overly long or irrelevant content, and suboptimal utilization of processing resources on both the server and user terminal.
Accordingly, there is a need for a technical architecture that: (i) unifies preprocessing of character-based information and feature generation for user-interest modeling; (ii) tightly integrates user-interest models with adaptive construction of prompt sentences for a generative AI model; (iii) incorporates real-time user behavior history and emotional state into the continuous updating of both the learned model and the prompt construction logic; and (iv) dynamically controls the amount, type, and style of information transmitted to and displayed on user terminals. Such an architecture should improve computational efficiency, reduce latency, and enhance the relevance and usability of generated responses in a way that constitutes a concrete improvement to computer-based information processing systems.

The specific processing by the specific processing unit 290 of the data processing device 12 in Application Example 1 is realized by the following means.

The present invention provides a server comprising a processor configured to acquire character-based information from a plurality of information sources, preprocess the character-based information using programmatically executed operations including at least cleaning, word segmentation, function word removal, stemming, and lemmatization, and convert the preprocessed character-based information into feature data for machine learning; to construct, using the feature data and user behavior information, a learned model that represents user interest and to calculate, by applying the learned model to new character-based information, a relevance index and thereby generate, for each user, an optimized information set by ranking the character-based information according to the relevance index; to construct a prompt sentence for a generative AI model on the basis of the optimized information set and user interest information, to input the prompt sentence together with at least part of the optimized information set into the generative AI model, and to receive summary information or explanatory information generated by the generative AI model and attach the summary information or explanatory information to the optimized information set to form presentation information; to acquire, as behavior history, at least browsing history, operation history, and evaluation information transmitted from a user terminal with respect to the presentation information, and to perform retraining or updating of the learned model on the basis of the behavior history so as to continuously adjust parameters of the learned model and structural elements of the prompt sentence; to analyze user character input using an affective analysis algorithm to estimate a user emotional state and, based on the estimated emotional state and response information obtained from the generative AI model, adjust at least one of expression content and presentation manner of the response information; and to transmit the ranked information set and the summary information or explanatory information to the user terminal via a communication path in a format suitable for display on the user terminal. This enables a computer-implemented system to internally coordinate text preprocessing, user-interest modeling, adaptive prompt construction for a generative AI model, behavior-history-driven model updating, and emotion-aware response control so that computational resources, network bandwidth, and latency are improved in comparison with conventional systems, while delivering more relevant and dynamically tailored information to the user.

The term “character-based information” refers to information expressed primarily as sequences of characters or text, including but not limited to documents, messages, queries, articles, titles, and summaries that can be processed by text-handling functions in a computing system.

The term “information source” refers to any origin of data accessible by a computing system, including but not limited to network services, databases, data feeds, storage devices, and application interfaces that provide character-based information.
The term “preprocessing” refers to a sequence of computational operations applied to raw character-based information in order to normalize, clean, and transform the information into a form suitable for further machine processing, such as machine learning, natural language processing, or generative modeling.
The term “cleaning” refers to a preprocessing operation that removes or normalizes undesired elements from character-based information, including at least markup, control characters, extraneous whitespace, and irrelevant symbols, in order to improve subsequent analysis.
The term “word segmentation” refers to a preprocessing operation that divides a sequence of characters into unit elements representing words or tokens according to syntactic or statistical rules, enabling word-level analysis of the character-based information.
The term “function word removal” refers to a preprocessing operation that removes from tokenized text words that primarily serve grammatical functions, such as articles, conjunctions, or prepositions, in order to reduce noise and highlight content-bearing terms.
The term “stemming” refers to a preprocessing operation that algorithmically reduces word forms to stem representations, typically by removing inflections or derivational suffixes, to consolidate variations of a word into a common base form.
The term “lemmatization” refers to a preprocessing operation that maps word forms to their canonical dictionary form, or lemma, using lexical or morphological rules, thereby normalizing related inflected or derived forms into a single representation.
The term “feature data” refers to structured numerical or symbolic representations derived from preprocessed character-based information, suitable for input to a machine learning algorithm, and may include but is not limited to vector, tensor, or categorical encodings.
The term “machine-learning data” refers to data prepared for use by a machine learning algorithm, including at least feature data and, where applicable, associated target values or labels for training, validation, or inference.
The term “user behavior information” refers to information describing interactions of a user with a computing system or content, including at least selection actions, viewing events, input operations, and explicit or implicit evaluations.
The term “learned model” refers to a computational model whose internal parameters or structure have been adjusted by a training process using machine-learning data, such that the model encodes patterns or relationships usable for prediction, classification, ranking, or generation.
The term “user interest” refers to one or more inferred or explicitly specified preferences of a user with respect to topics, categories, content types, or styles, as represented within a learned model or other data structures in a computing system.
The term “relevance index” refers to a numerical or ordered indicator computed by a learned model or algorithm, representing a degree of relatedness or suitability of particular information with respect to a specific user or user interest.
The term “optimized information set” refers to a collection of character-based information items selected, ranked, or filtered on the basis of at least a relevance index and user interest, such that the collection is tailored to improve usefulness for a specific user.
The term “generative AI model” refers to a machine-implemented model configured to generate new character-based information, such as summaries, explanations, or responses, based on input data and internal learned parameters obtained through a training process.
The term “prompt sentence” refers to a structured character-based instruction or query, optionally including contextual information, provided as input to a generative AI model to specify a desired output type, style, scope, or behavior of the model.
The term “summary information” refers to character-based information generated or derived to represent a condensed form of one or more source items, capturing at least principal points or concepts in a shorter or simpler format.
The term “explanatory information” refers to character-based information that clarifies, interprets, or elaborates on one or more source items, including but not limited to descriptions, rationales, or contextual commentary.
The term “presentation information” refers to a set of character-based information, including at least original content, summary information, or explanatory information, arranged or formatted for output to and display on a user terminal.
The term “user terminal” refers to any computing apparatus operated by or on behalf of a user, including but not limited to mobile devices, personal computers, and display-equipped communication devices, capable of receiving, processing, and presenting information from a server.
The term “behavior history” refers to stored user behavior information accumulated over time, including sequences or aggregates of events such as browsing history, operation history, and evaluation information associated with presentation information.
The term “browsing history” refers to a subset of behavior history that records user access or viewing events related to information items, including identifiers of viewed items, viewing times, durations, and navigation paths.
The term “operation history” refers to a subset of behavior history that records user-initiated actions other than mere viewing, including at least selections, clicks, scrolls, saves, shares, and other interactive commands.
The term “evaluation information” refers to user-provided or inferred assessments of information or system output, including explicit ratings, likes or dislikes, ranking choices, textual feedback, or implicit measures such as dwell time or abandonment.
The term “retraining” refers to a process in which a previously learned model is trained again using updated or additional machine-learning data, thereby modifying the model parameters to reflect new patterns or changes in user behavior or content.
The term “updating of the learned model” refers to any modification of parameters, structure, or stored state of a learned model, including but not limited to retraining, incremental learning, or fine-tuning based on new data.
The term “affective analysis algorithm” refers to an algorithm executed by a computing system to estimate an emotional or affective state based on character-based information, such as user text input, using techniques including but not limited to sentiment analysis or emotion classification.
The term “emotional state” refers to a representation of a user's inferred affective condition, such as positivity, negativity, neutrality, or specific emotions, as determined by an affective analysis algorithm.
The term “expression content” refers to the wording, tone, style, and linguistic structure of character-based output presented to a user, including the selection and arrangement of phrases, sentences, and emphasis.
The term “presentation manner” refers to the way in which information is delivered or displayed to a user, including at least format, layout, granularity, timing, and interaction modality on a user terminal.
The term “response information” refers to character-based output generated or selected by a computing system in reply to user input or in association with presentation information, including information obtained from a generative AI model.
The term “communication path” refers to any wired or wireless communication medium or protocol arrangement enabling data transfer between a server and a user terminal, including but not limited to network connections and associated communication layers.
The term “output control condition” refers to one or more parameters, constraints, or rules used to control the behavior of a generative AI model or the post-processing of its outputs, such as length limits, style constraints, topic focus, or filtering criteria.

In one embodiment, a server implements the claimed system as a network-connected computing apparatus that cooperates with one or more terminals operated by users. The server includes at least one general-purpose processor, a main memory, a non-volatile storage device, and a network interface. The server executes an operating system such as a general-purpose server operating system and application software including a web application framework, a natural language processing library, a machine learning library, and, in some embodiments, a deep learning framework. The server communicates with terminals, such as smartphones, tablet devices, or personal computers, via wired or wireless networks using a communication protocol such as HTTP or HTTPS.

The server stores, in the non-volatile storage device, program modules including a data collection module, a text preprocessing module, a feature generation module, a user-interest modeling module, a prompt construction module, a generative AI interaction module, a behavior logging module, an affective analysis module, and a presentation control module. The server loads these modules into the main memory and executes them by the processor. In one example configuration, the server uses a relational database management system to store character-based information and user behavior history, and uses a cache system for storing frequently accessed ranking results and intermediate data.
The server acquires character-based information from a plurality of information sources such as content feeds, database endpoints, and web pages. The server uses an HTTP client library, operating on the processor, to transmit HTTP requests and receive HTTP responses. The server then parses received content using a markup parser or a data parser and normalizes the content into a common data structure, for example a record structure comprising fields such as an identifier, a title, a body text, a category label, a timestamp, and a source identifier. The server stores these records in a database table where each row corresponds to one character-based information item.
The server preprocesses the acquired character-based information by executing a text preprocessing module implemented using a natural language processing library. The server performs cleaning by removing markup tags, scripts, and control sequences, converting text to a normalized character encoding, unifying letter case, and removing or normalizing extraneous symbols. The server performs word segmentation by applying a tokenizer that divides each character sequence into tokens based on language-specific rules and punctuation. In some embodiments, the server performs function word removal by comparing tokens against a stored stop-word list and discarding tokens that match list entries. The server performs stemming or lemmatization by applying morphological transformation rules to map inflected or derived forms to stems or lemmas. The server stores the preprocessed tokens or normalized text for each item in a dedicated database column and sets a processing status flag indicating completion of preprocessing.
The server generates feature data by converting preprocessed character-based information into numerical vectors. The server uses, for example, a term frequency-inverse document frequency (TF-IDF) method implemented in a machine learning library to calculate weights for each token relative to a vocabulary derived from the entire corpus or a selected subset. The server represents each information item as a sparse vector whose dimensions correspond to vocabulary entries and whose values correspond to TF-IDF weights. The server stores these vectors in a feature store or serializes them to disk in an efficient sparse matrix format. In an alternative embodiment, the server uses word embedding or document embedding methods, such as a neural network-based embedding model, to obtain dense vectors. In this case, the server executes a neural network model with an input layer receiving token identifiers, one or more hidden layers computing embeddings, and an output layer providing a fixed-length real-valued vector representation for each item.
The server constructs a learned model representing user interest by processing feature data together with user behavior information. The server stores user behavior information, such as identifiers of items that a user selected, viewing durations, and evaluation inputs, in a behavior history table. The server converts behavior history into training labels or target values; for example, the server assigns a positive label to items that a user read for longer than a threshold time, and assigns a negative label to items that were displayed but not selected. The server associates these labels with the corresponding feature vectors of the items to create supervised learning data.
The server trains a user-interest model using a machine learning algorithm. In one embodiment, the server uses a linear classifier with an input layer receiving the feature vector, a weight matrix representing feature importance for relevance, and a loss function such as logistic loss. The server computes gradients of the loss function with respect to the weights and updates the weights by an optimization method such as stochastic gradient descent. The server iterates this optimization process until convergence criteria are met. In another embodiment, the server uses a neural network architecture with one or more hidden layers and a non-linear activation function, thereby enabling modeling of complex interactions between features. The server defines an error function, for example cross-entropy loss between predicted relevance probabilities and actual labels, and updates network weights by backpropagation using an optimizer such as Adam or RMSProp. The server stores trained model parameters in a model repository associated with user identifiers or user segments.
The server calculates a relevance index for new character-based information by applying the learned model to the feature vectors of the new items. The server performs matrix-vector operations where the feature vector of an item is multiplied by the learned weight matrix and passed through the model's activation function to obtain a scalar score. The server interprets this score as a measure of the degree of match between the item and the user's interest. The server ranks items for each user according to the scores and constructs an optimized information set by selecting the top-ranked items and optionally enforcing constraints such as diversity of categories or recency thresholds.
The server constructs a prompt sentence for a generative AI model to generate summary information or explanatory information tailored to the user. The server uses the optimized information set and user interest information as inputs to a prompt construction module. The server retrieves metadata about user interest, such as topic distributions inferred by the learned model or stored preference profiles, and incorporates such metadata into a natural-language template. For example, the server generates prompt sentences such as:
“The user is highly interested in technology and health. Read the following article titles and summaries, then generate a clear, 200-word morning briefing that highlights the most important technology and health news for this user.”
“Based on the user's interest in AI, gadgets, and preventive healthcare, summarize the top 5 most relevant recent articles into a short, bullet-point digest. Emphasize practical insights and avoid unnecessary technical details.”
“The user often reads about software engineering, cybersecurity, and mental health. Using the provided article headlines and abstracts, produce a friendly, conversational overview that connects these topics and explains why each article may be valuable to the user.”
The server appends to such a prompt sentence context information including titles, key sentences, or abstracts of selected items from the optimized information set. The server then transmits the prompt sentence and context to an external or internal generative AI model via a network API or function call interface. In one embodiment, the generative AI model is implemented as a transformer-based neural network with multiple self-attention layers, positional encoding, and a decoder architecture that generates tokens sequentially. The server sets generation parameters such as maximum output length, temperature, and nucleus sampling threshold to control output variability and length.
The server receives from the generative AI model character-based output corresponding to summary information or explanatory information. The server may perform post-processing such as truncating overly long responses, removing inappropriate content using a rule-based filter or content classifier, or normalizing line breaks and punctuation. The server then associates the generated summary information with the relevant items in the optimized information set and stores the combined data as presentation information ready to be delivered to terminals.
The terminal receives presentation information from the server via a communication path. The terminal operates under the control of a processor and an operating system and executes a client application or a web browser. The terminal decodes the received data structure, for example a structured text or markup representation, and renders the optimized information set and the associated summary information or explanatory information on a display. The terminal arranges user interface elements such that original item titles and summaries are displayed together with generative AI-created digests or explanations, and such that interactive controls for selection, evaluation, or feedback are provided.
The user operates the terminal to read displayed content and to provide actions such as selecting items, scrolling through the list, submitting evaluations (for example, marking content as helpful or not helpful), or entering free-text feedback. The terminal detects these actions and records behavior information including item identifiers, timestamps, dwell times, and evaluation values. The terminal transmits behavior information to the server over the communication path. In some embodiments, the terminal aggregates multiple events into batches to reduce network overhead and adds device-specific identifiers or context, such as network conditions or available display area, for use in subsequent optimization by the server.
The server acquires transmitted behavior information and stores it as behavior history. The server uses the behavior history to retrain or update the learned model by executing the same or a modified training algorithm. For example, the server may perform incremental learning by calling a partial update function in the machine learning library to adjust model weights based on newly collected labeled data without retraining from scratch. In other embodiments, the server periodically performs full retraining on an expanded dataset that includes older and newer behavior history. The server thereby adapts the learned model to evolving user interests, which in turn modifies the relevance index used for ranking.
The server executes an affective analysis module to analyze user character input, such as text queries, comments, or evaluation messages, using an affective analysis algorithm. The server tokenizes and normalizes the user text, maps tokens into an embedding space using a pre-trained embedding model or a lookup table, and inputs the resulting vectors into a sentiment or emotion classifier. This classifier may be a neural network, for example a recurrent or transformer-based network with an output layer that predicts probabilities for discrete emotion categories. The server interprets the output probabilities as an estimated emotional state and selects an emotion label or a scalar sentiment score based on a decision rule such as maximum probability or thresholding.
The server adjusts expression content and presentation manner of response information according to the estimated emotional state. For example, the server modifies prompt sentences to instruct the generative AI model to produce more concise and neutral responses when the user appears frustrated, or more detailed and enthusiastic explanations when the user appears highly engaged. The server also controls parameters such as output length and level of technical detail by inserting explicit constraints into the prompt sentence. Because this adjustment is performed automatically and systematically at the server level, the server avoids repeated generation of overly long or irrelevant responses, thereby reducing computational load and network traffic.
The server dynamically adjusts the amount and type of information sent to the terminal by considering both the relevance index and the emotional state. For instance, when behavior history indicates that a user consistently skips large blocks of text, the server reduces the number of items or condenses content through more aggressive summarization. When the network conditions are poor, as reported by the terminal or inferred by the server from connection metrics, the server further compresses content or limits the number of transmitted items to minimize retransmissions and latency. These adjustments are implemented by modifying query parameters in database retrieval and by changing generation parameters in the generative AI model invocation.
From a technical standpoint, the server improves computer technology in several ways. By unifying text preprocessing and feature generation for both user-interest modeling and prompt construction, the server avoids redundant computation and reduces memory footprint, because the same normalized representations serve multiple modules. By continuously updating the learned model based on fine-grained behavior history and immediately feeding changes into prompt construction, the server reduces the number of irrelevant or low-value generation requests sent to the generative AI model, which reduces processing time and bandwidth usage. By using affective analysis to control the form and volume of outputs, the server ensures that the generative AI model processes only content that is likely to match user state, thereby improving overall efficiency.
In one embodiment, the server implements internal data structures specifically designed to support these improvements, such as: a user profile structure that stores parameterized representations of user interest vectors; a prompt template structure that includes placeholders for user interest descriptors, emotional modifiers, and content selection pointers; and a tracking structure that associates prompt versions with user feedback and engagement metrics. The server analyzes these tracking records to automatically refine prompt templates by selecting variations that lead to higher engagement or lower abandonment rates, using statistical tests or reinforcement learning. This non-conventional feedback loop between user behavior, emotional state, prompt construction, and generative output selection enables the server to optimize system-level performance beyond simple automation of human content curation.
In another embodiment, the server employs a neural ranking architecture that combines content-based features and behavior-based features in a single model. The server constructs a feature vector concatenating a document embedding, a user interest embedding, and behavior-derived features such as recent click frequency in particular categories. The server inputs this concatenated vector into a multi-layer neural network trained with a pairwise or listwise ranking loss function, such as a hinge loss or a softmax-based listwise loss. The server updates network weights by backpropagation to optimize ranking quality metrics. By implementing such a learned ranking model, the server achieves more accurate and stable ordering of items than conventional heuristic or manually tuned algorithms.
In yet another embodiment, the server uses separate modules for short-term and long-term interest modeling, where one model processes recent behavior history and another processes aggregated historical behavior. The server combines outputs of these models by a weighted scheme that depends on time decay parameters or detected shifts in user interest. This configuration further improves accuracy and responsiveness of the system, because the server can quickly react to trending interests while preserving knowledge of persistent preferences. The terminal, in all of these embodiments, remains relatively simple in terms of computation, primarily handling user interface rendering and local event capture. Most of the complex processing, including feature extraction, model learning, prompt adaptation, generative interaction, and emotion-aware control, takes place in the server. This division of labor reduces computational demands on the terminal and allows centralized optimization of algorithms and data structures on the server side, resulting in globally improved processing speed and reduced overall resource consumption.
Through these configurations, the server does not merely automate human recommendation or summarization tasks. Instead, the server implements specific technical mechanisms—unified text preprocessing pipelines, feature-based learning models, emotion-driven output control, and feedback-linked prompt adaptation—that change how the computing system internally stores, processes, and transmits information. These mechanisms yield measurable technical effects such as reduced latency in generating personalized content, improved ranking accuracy, lower error rates in matching content to user interest and emotional state, reduced network load due to more targeted content delivery, and improved utilization of processing resources in both the server and terminals.

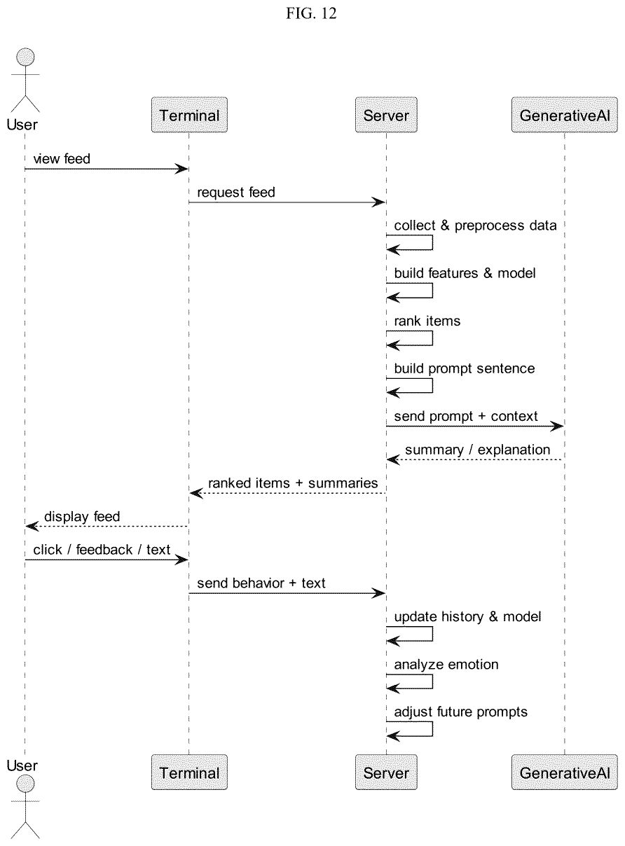

The following describes the processing flow using FIG. 12.

### Step 1:

The server acquires character-based information from multiple information sources.
The input to this step is a list of source identifiers and access endpoints, such as URLs of content feeds, database queries, or application interfaces. The server issues network requests using an HTTP client to each endpoint and receives raw content data, such as HTML documents, JSON structures, or plain text. The server parses the received content using a parser and extracts fields including at least an item identifier, a title, a body text, a category indicator, a timestamp, and a source identifier. The output of this step is a set of normalized content records that the server stores in a database table, each record having a unified schema regardless of the original source format.

### Step 2:

The server preprocesses the stored character-based information to generate cleaned and tokenized text.
The input to this step is the set of normalized content records retrieved from the database that are marked as “unprocessed.” The server applies text cleaning operations to each record's title and body text, including removal of markup tags and scripts, conversion of text to a standard character encoding, lowercasing, and elimination of extraneous symbols. The server then executes word segmentation to split the cleaned text into tokens. The server removes function words by comparing tokens against a stored list of stop-words and discarding matching tokens. The server applies stemming or lemmatization to the remaining tokens to reduce inflected forms to canonical base forms. The output of this step is, for each content record, a sequence of normalized tokens or a normalized text string, which the server stores in a separate database field and marks as “preprocessed.”

### Step 3:

The server converts the preprocessed text into feature data suitable for machine learning.
The input to this step is the set of preprocessed text fields associated with content records.
The server builds a vocabulary across the corpus and computes statistical measures such as term frequencies and inverse document frequencies. The server then performs a mathematical transformation that maps each preprocessed text into a numerical feature vector; for example, the server computes a sparse vector whose components are TF-IDF weights for vocabulary terms present in the text. The server optionally computes additional features, such as document length, category indicators, or source reliability scores, and appends them to the vector. The output of this step is a feature matrix in which each row corresponds to a content record and each column corresponds to a feature dimension. The server stores this matrix or a serialized equivalent, together with an index mapping between record identifiers and feature vectors.

### Step 4:

The server constructs and trains a learned model representing user interest.
The input to this step is the feature matrix for content records and user behavior information such as clicks, viewing durations, and evaluations recorded for those records. The server joins feature vectors with behavior labels by matching record identifiers to user interaction logs. The server assigns target values (for example, 1 for relevant, 0 for not relevant, or graded scores) to create supervised training data. The server feeds the feature vectors and target values into a learning algorithm, such as a linear classifier or a neural network. The server computes loss values using a defined loss function, calculates gradients with respect to model parameters, and updates the parameters using an optimization algorithm like stochastic gradient descent. The output of this step is a trained user-interest model whose internal parameters encode correlations between features and user relevance; the server stores the model parameters in a model repository associated with a user or user segment.

### Step 5:

The server computes a relevance index for new content items and generates an optimized information set for each user.
The input to this step is the trained user-interest model, the feature vectors of new or updated content records, and identifiers of target users. The server applies the same feature-generation process to new content to obtain compatible vectors, then feeds these vectors into the trained model. The server performs numerical operations, such as matrix multiplication and activation function evaluation, to compute a relevance score for each (user, content) combination. The server sorts content items for each user in descending order of the relevance score, and applies constraints such as category diversity or time-based filtering to refine the selection. The output of this step is, for each user, an optimized information set consisting of a ranked list of content item identifiers and associated metadata, which the server stores in a ranking table or cache.

### Step 6:

The server constructs a prompt sentence for a generative AI model based on the optimized information set and user interest information.
The input to this step is the optimized information set for a specific user and the user's interest profile derived from the learned model or a stored preference record. The server selects a subset of top-ranked items and extracts text elements such as titles, short summaries, or leading paragraphs. The server generates a natural-language prompt sentence by filling a template with user interest descriptors and control instructions for style, length, and structure. For example, the server generates prompt sentences such as: “The user is highly interested in technology and health. Read the following article titles and summaries, then generate a clear, 200-word morning briefing that highlights the most important technology and health news for this user.” The server concatenates the prompt sentence with the selected content excerpts to form a single input context. The output of this step is a structured input text that includes both a prompt sentence and contextual article information, ready to be transmitted to the generative AI model.

### Step 7:

The server interacts with the generative AI model to obtain summary information or explanatory information.
The input to this step is the structured input text that includes the prompt sentence and associated content excerpts, along with generation parameters such as maximum output length, temperature, and response format constraints. The server transmits this input to the generative AI model via an API or internal call, and the generative AI model processes the text using a neural network architecture, such as a transformer with multiple attention layers, to generate output tokens. The server receives the generated character-based output from the generative AI model and optionally performs post-processing operations such as truncating text beyond a length threshold, filtering out prohibited terms using rule-based checks, and normalizing spacing and punctuation. The output of this step is a piece of summary information or explanatory information in text form that is aligned with the selected content items.

### Step 8:

The server integrates the generated information with the optimized information set to create presentation information.
The input to this step is the optimized information set and the generated summary or explanatory text obtained from the generative AI model. The server associates the generated text with either the entire set or specific items by inserting references or identifiers. The server constructs a structured representation of presentation information that includes original item metadata, selected excerpts, and one or more generated summaries or explanations. The server determines how many generated elements to attach and in what order, based on configuration rules or user preferences. The output of this step is a formatted presentation package for each user, which the server stores temporarily in memory or in a presentation table and prepares for transmission.

### Step 9:

The server transmits the presentation information to the terminal, and the terminal displays it to the user.
The input to this step is a request from the terminal specifying a user identifier and optionally parameters such as page number or display size, and the corresponding presentation package stored by the server. The server retrieves the package, serializes it into a transfer format such as structured text or markup, and sends it over a communication path via a network interface. The terminal receives the transmitted data, parses the structure into internal objects, and maps them onto visual components such as lists, cards, or panels. The terminal invokes its graphical subsystem to draw titles, summaries, and generative AI-produced explanations on the display in the order dictated by the ranking. The output of this step is a rendered user interface on the terminal that visibly presents the ranked content and associated generated information.

### Step 10:

The user interacts with the displayed information, and the terminal records behavior information.
The input to this step is the rendered user interface containing items and interactive controls, as well as user actions such as taps, clicks, scrolls, and text entries. The user selects items to read in detail, scrolls through the content list, and may submit feedback such as “helpful” or “not helpful” for summaries. The terminal detects each interaction event, attaches metadata including item identifiers, timestamps, and screen context, and calculates derived values such as viewing duration or scroll depth. The terminal aggregates these events in a local buffer and periodically packages them into behavior records. The output of this step is a batch of behavior records representing browsing history, operation history, and evaluation information, which the terminal transmits to the server over the network.

### Step 11:

The server updates behavior history and retrains or updates the learned model based on the new data.
The input to this step is the batch of behavior records received from the terminal and the current parameters of the learned model. The server writes the behavior records into a persistent behavior history store and derives training labels or weighting factors from them, for example by marking items with long viewing times and positive evaluations as highly relevant. The server constructs additional training examples by pairing feature vectors of those items with updated labels and merges them with existing training data. The server then invokes a retraining or incremental learning procedure, recalculating gradients of the loss function on the augmented dataset and updating model parameters accordingly. In online-learning implementations, the server calls a partial fitting function that adjusts the model incrementally with each new batch. The output of this step is an updated learned model that more accurately reflects current user interests, which the server stores and uses in subsequent relevance computations.

### Step 12:

The server analyzes user character input to estimate emotional state and adjusts response information accordingly.
The input to this step is user text input, such as queries, comments, or feedback messages, and the response information previously obtained from the generative AI model. The server preprocesses the user text by tokenizing and normalizing it, converts tokens into numerical representations using an embedding model, and feeds the resulting vectors into an affective analysis algorithm, such as a neural network classifier for emotion categories or sentiment polarity. The server interprets the classifier outputs as a probability distribution over emotional states and selects an emotional label or score. The server then adjusts the expression content and presentation manner of future or pending response information by modifying prompt sentences to reflect the emotional state, for example by instructing the generative AI model to be more concise or more supportive. The output of this step is an updated set of prompt sentence parameters and response formatting rules that the server applies when generating and delivering subsequent presentation information.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional dialog systems that utilize natural language processing and machine learning often treat user input as a flat sequence of characters or tokens and directly pass such input to a generative model. In many implementations, a computing device merely forwards the raw user question to a generative model and returns the generated text, without performing structured syntactic analysis, explicit semantic intent extraction, or fine-grained sentiment analysis. As a result, the computing device cannot reliably capture sentence structure, cannot consistently disambiguate user intent, and cannot adapt the response style or content to the emotional state of the user.

Furthermore, typical systems do not construct a structured intermediate representation that combines syntactic information, semantic intent, sentiment information, and external knowledge obtained from one or more information providing systems. Instead, such systems rely on the internal behavior of the generative model in an opaque manner. This leads to technical limitations in controllability of the generated content, difficulty in systematically incorporating external data sources, and reduced robustness and predictability of the response generation pipeline executed by the processor.
In addition, in many existing architectures, the processor does not maintain a feedback loop that uses user behavior and user reactions to refine the upstream analysis modules and prompt construction logic. Without such feedback, the processor cannot technically improve the accuracy and stability of syntactic parsing, semantic interpretation, sentiment estimation, and prompt generation over time. This results in inefficient use of computing resources, because the same processing errors are repeated and the generative model is queried with suboptimal prompts, increasing computational cost and latency while degrading overall system quality. Moreover, conventional systems often provide limited control over the style, length, and content of the generated answer based on the user's emotional state. The processor typically does not dynamically modify prompt structure or output constraints in response to sentiment information. Consequently, the generated responses can be emotionally mismatched, overly long or too short, and may fail to provide appropriate emphasis or reassurance, which can degrade user experience and reduce the effective throughput of the computing infrastructure. Accordingly, there is a need for an improved computer-implemented technique in which a processor: (i) decomposes a user question into explicit syntactic and semantic representations; (ii) augments such representations with sentiment information and external knowledge; (iii) constructs a controlled prompt sentence for a generative model based on this structured representation; (iv) uses feedback data derived from actual user interactions to update at least parts of the analysis and prompt generation pipeline; and (v) dynamically changes the expression policy and output conditions in the prompt according to the detected emotional state, thereby technically improving controllability, robustness, efficiency, and adaptability of the overall dialog processing performed by the computing system.

The specific processing by the specific processing unit 290 of the data processing device 12 in Example 2 is realized by the following means.

The present invention provides a server comprising a processor configured to receive, from a user terminal, a question sentence expressed in a natural language and perform syntactic analysis processing on the question sentence to generate sentence structure information; perform semantic analysis processing based on the sentence structure information to extract lexical meaning information and intent information of the question and to generate semantic representation data including the intent information of the question; perform sentiment analysis processing on the question sentence to estimate emotion state information of a user and to add the emotion state information to the semantic representation data; acquire related information from at least one external information providing apparatus based on the intent information included in the semantic representation data and to add the related information to the semantic representation data; generate a prompt sentence to be input to a generative model based on the question sentence, the semantic representation data, the emotion state information, and the related information; input the prompt sentence to the generative model so as to cause the generative model to generate an answer sentence expressed in a natural language and transmit the generated answer sentence to the user terminal; collect usage history information of the user and response information to the answer sentence and update at least part of the syntactic analysis processing, the semantic analysis processing, the sentiment analysis processing, or processing for generating the prompt sentence by using the usage history information and the response information as feedback data; and dynamically change expression policy information or output condition information included in the prompt sentence according to the emotion state information to adjust at least one of a style, a length, or content of the answer sentence output from the generative model. This enables the computing system to build a structured intermediate representation combining syntax, semantics, sentiment, and external knowledge, to generate optimized prompt sentences for the generative model, to iteratively refine the analysis and prompt generation pipeline based on real user feedback, and to adapt the characteristics of the generated answer to the detected emotional state, thereby improving technical performance in terms of response accuracy, controllability, robustness, and computational efficiency.

The term “user terminal” refers to an information processing device operated by a user, including but not limited to a communication device, a computing device, or a display device, that transmits a question sentence to the server and receives an answer sentence from the server.

The term “question sentence” refers to a sequence of characters or tokens expressed in a natural language that represents an inquiry, request, or instruction input by the user to the system.
The term “natural language” refers to a human language used for everyday communication, including but not limited to spoken language or written language, as opposed to a programming language or a formal logic language.
The term “syntactic analysis processing” refers to processing executed by a processor to analyze the grammatical structure of a question sentence, including but not limited to tokenization, part-of-speech tagging, and parsing, and to generate sentence structure information.
The term “sentence structure information” refers to data representing grammatical relationships within a question sentence, including but not limited to identification of subjects, predicates, objects, modifiers, and dependency relationships among tokens.
The term “semantic analysis processing” refers to processing executed by a processor to extract meaning-related information from a question sentence or sentence structure information, including but not limited to identification of important terms, entities, and intent, and to generate semantic representation data.
The term “lexical meaning information” refers to data indicating meanings or semantic roles associated with words or phrases in the question sentence, including but not limited to concept categories, entity types, or role labels.
The term “intent information” refers to data representing a purpose, goal, or type of request implied by the question sentence, including but not limited to a request for information, an instruction to perform an operation, or a request for an explanation.
The term “semantic representation data” refers to structured data generated by semantic analysis processing that represents the meaning of a question sentence, including at least intent information and optionally including entities, parameters, and contextual attributes.
The term “sentiment analysis processing” refers to processing executed by a processor to estimate an emotional tendency or attitude expressed in a question sentence, including but not limited to classifying sentiment into positive, negative, or neutral, and determining an intensity of such sentiment.
The term “emotion state information” refers to data indicating an estimated emotional condition of a user based on sentiment analysis processing, including but not limited to labels, scores, or categories representing user emotions.
The term “external information providing apparatus” refers to an information supply system or data source coupled to the server via a communication network, including but not limited to a database system, an information service system, or a knowledge management system, that returns related information in response to a query.
The term “related information” refers to data acquired from an external information providing apparatus based on intent information, including but not limited to factual data, reference information, or domain-specific knowledge relevant to the question sentence.
The term “prompt sentence” refers to a text string or data structure constructed by the processor to be provided as input to a generative model, the text string or data structure including at least a representation of the user's question and one or more of semantic representation data, emotion state information, or related information.
The term “generative model” refers to a machine learning model that, in response to an input such as a prompt sentence, generates an output sequence expressed in a natural language, such as a language model configured to produce text.
The term “answer sentence” refers to a sequence of characters or tokens expressed in a natural language generated by the generative model based on a prompt sentence and transmitted from the server to the user terminal as a response to the question sentence.
The term “usage history information” refers to data representing past interactions between a user and the system, including but not limited to records of question sentences, answer sentences, timestamps, and interaction contexts.
The term “response information” refers to data indicating a reaction or evaluation associated with an answer sentence, including but not limited to explicit user feedback, subsequent user behavior, or implicit indicators of satisfaction or dissatisfaction.
The term “feedback data” refers to a combination of usage history information and response information that is used by the processor to adjust or retrain at least part of syntactic analysis processing, semantic analysis processing, sentiment analysis processing, or prompt sentence generation processing.
The term “expression policy information” refers to data that defines a style or manner in which an answer sentence should be generated, including but not limited to politeness level, formality, tone, perspective, or degree of detail.
The term “output condition information” refers to constraints or parameters that control characteristics of an answer sentence, including but not limited to a maximum length, minimum length, target language, structure, or inclusion of specific elements.
The term “style of the answer sentence” refers to a qualitative aspect of the generated answer sentence, including but not limited to tone, politeness, formality, or narrative manner.
The term “length of the answer sentence” refers to a quantitative measure of the generated answer sentence, including but not limited to a number of characters, a number of tokens, or a number of sentences.
The term “content of the answer sentence” refers to substantive information contained in the generated answer sentence, including but not limited to facts, explanations, recommendations, and expressions selected based on semantic representation data, emotion state information, and related information.

In one embodiment, a server cooperates with one or more terminals used by a user to provide natural-language answers generated by a generative AI model. The server includes at least one processor, a main memory, a nonvolatile storage device, and a network interface. The processor executes an operating system, such as a general-purpose server operating system, and application software that implements natural language analysis, sentiment analysis, external information acquisition, prompt sentence generation, and interaction with a generative AI model. The nonvolatile storage device stores trained model parameters, configuration data, and logs, while the main memory stores intermediate data structures used during processing.

A terminal includes a processing unit, a display unit, an input unit, a communication unit, and a storage unit. The terminal executes an operating system, such as a mobile OS or a desktop OS, and an application or web browser that provides a graphical user interface. The terminal displays an input field through which the user supplies a question sentence in a natural language and transmits the question sentence to the server over a communication network. The user operates the terminal to input a question sentence, such as “What will the weather be like today in Tokyo?”. The terminal converts the user's keystrokes or speech input into text data, stores the text data temporarily in the terminal memory, and transmits the text data to the server via the communication unit using a communication protocol, such as HTTP over TLS. The terminal further receives an answer sentence from the server and displays the answer sentence on the display unit as part of a dialog interface.
The server stores a syntactic analysis module, a semantic analysis module, a sentiment analysis module, an external information access module, a prompt generation module, an interaction module for the generative AI model, and a feedback learning module. The server configures each module as a software component that operates on structured data held in memory, and defines explicit interfaces among the modules so that data flow is deterministic and traceable.
The server uses a syntactic analysis module to process the question sentence and to generate sentence structure information. In one embodiment, the server uses a natural language toolkit library to perform tokenization, part-of-speech tagging, and dependency parsing. The server represents the result of syntactic analysis as a tree structure or directed graph stored in memory, where each node corresponds to a token with attributes including a token identifier, lexical form, part-of-speech tag, and dependency relation, and where each edge indicates a grammatical relation. The server thereby enables the processor to perform downstream processing using explicit grammatical relationships, rather than relying on an opaque black-box behavior.
The server uses a semantic analysis module to convert the sentence structure information into semantic representation data. In one embodiment, the server uses a natural language processing library that provides named entity recognition and dependency-based relation extraction. The server maps nodes and edges in the syntactic structure to a frame-like semantic structure, including fields such as “intent”, “domain”, “parameters”, and “entities”. For example, for the question sentence “What will the weather be like today in Tokyo?”, the server stores a semantic representation including an intent field set to “request_weather_forecast”, a location parameter set to “Tokyo”, and a date parameter set to “today”. The server thereby converts an unstructured character sequence into a normalized data structure that can be handled efficiently by the processor and by other modules.
The server uses a sentiment analysis module to estimate emotion state information of the user. In one embodiment, the server uses a lexicon-based intensity analyzer or a neural classifier as a sentiment analysis engine. The server converts the question sentence into feature vectors, for example by assigning sentiment scores to tokens and aggregating the scores with weights based on part-of-speech tags and dependency roles. In another embodiment, the server uses a small neural network that receives token embeddings and outputs a sentiment label and confidence scores. The server stores emotion state information, such as “neutral”, “positive”, or “negative”, as fields in the semantic representation data. The server may further store continuous sentiment scores and associate them with the question identifier, enabling later use in prompt construction and feedback learning.
The server uses an external information access module to obtain related information from at least one external information providing apparatus. In one embodiment, the server uses an application programming interface client to send a structured request including intent information and parameter values (such as location and date) to an external information system, such as a data repository or a knowledge base. The external information providing apparatus returns structured data, such as key-value pairs or table rows. The server parses the returned data and stores selected fields as related information in the semantic representation. For example, the server may store “weather: sunny”, “high_temperature: 25 degrees Celsius”, and “low_temperature: 18 degrees Celsius” in association with the question. By using this explicit integration point, the server can systemically control when and how external data is merged into the prompt sentence, improving determinism and transparency compared to approaches that rely solely on the generative AI model's internal knowledge.
The server uses a generative AI model as a text generation engine. In one embodiment, the server uses a neural network model in an encoder-decoder or decoder-only architecture configured for language modeling. The server stores model parameters in a nonvolatile storage device and loads them into the main memory when the model is used. The generative AI model may be represented as a sequence of layers, including an embedding layer, multiple attention layers, feed-forward layers, and a final projection layer. The server configures the model to receive a tokenized representation of a prompt sentence and to output a sequence of tokens that constitutes an answer sentence.
The server constructs the prompt sentence in the prompt generation module using a rule-based procedure that uses the semantic representation data, emotion state information, and related information as explicit inputs. The server does not directly pass the raw question sentence to the generative AI model. Instead, the server concatenates or templates multiple segments into a single prompt sentence, labeling segments clearly and enforcing a fixed ordering. For example, the server may generate a prompt sentence such as:
You are a helpful assistant.
User question: “What will the weather be like today in Tokyo?”

### Analysis:

Intent: request_weather_forecast
Location: Tokyo
Date: today
Sentiment: neutral
External data:
Condition: sunny
High temperature: 25 degrees Celsius
Low temperature: 18 degrees Celsius
   Using the information above, generate a clear and concise answer to the user.
   The server uses a data structure in memory to represent the prompt sentence before it is converted into a token sequence. This data structure includes fields indicating segment boundaries and segment types. The server thereby controls which information is presented to the generative AI model and in what format. This design improves reproducibility and allows the server to modify individual components, such as expression policy or external data, without changing the overall interaction pattern.
   In another example, when the user expresses anxiety, the server may generate a prompt sentence such as:
   You are an assistant that also considers the user's emotions.
   User question: “I'm really worried about tomorrow's rain in Osaka. Will it be very heavy?”

### Analysis:

Intent: request_weather_forecast
Location: Osaka
Date: tomorrow
Sentiment: negative (anxious)
   External data:
Condition: light rain
Expected rainfall: 3 millimeters
No storm or flood warnings
   Please generate a short, accurate, and reassuring answer based on the data above.
   The server uses emotion state information to select a different expression policy, leading to a different style and tone of the generated answer sentence. In this prototype, the server embeds the instruction “reassuring answer” into the prompt sentence, which affects the generative AI model output deterministically based on the constructed text.
   The server may further handle general knowledge questions that do not require external data. In such cases, the server sets the external data field to indicate that no external data is required and composes a prompt sentence such as:
   You are an expert assistant.
   User question: “What is a generative AI model?”

### Analysis:

Intent: Definition_request
Sentiment: neutral
   No external data is required.
   Please provide a concise explanation of what a generative AI model is, in two or three sentences, suitable for a non-expert user.
   By forming the prompt sentence in this structured and rule-based manner, the server improves the controllability of the generative AI model, reduces variance in answer style, and ensures that the same semantic state leads to similar prompts and similar answer characteristics.
   The server uses the interaction module to convert the prompt sentence into a token sequence, configure generation parameters such as maximum token count, sampling temperature, or beam width, and invoke the generative AI model on a hardware accelerator or general-purpose processor. The server then collects the output token sequence and converts it back into an answer sentence string. The server may perform additional checks, such as output length limitation, character encoding validation, and safety filters, before transmitting the answer sentence to the terminal.
   The server uses a feedback learning module to update at least part of the syntactic analysis module, semantic analysis module, sentiment analysis module, or prompt generation module based on usage history information and response information. The server stores, for each session, the question sentence, the constructed semantic representation, the selected prompt sentence, the answer sentence, and the user interaction pattern following the answer. For example, the server may store whether the user quickly submits a follow-up question requesting clarification, which may indicate that the previous answer was insufficient.
   The server may use a supervised learning or reinforcement learning framework to optimize parameters in the analysis modules and prompt generation rules. In one embodiment, the server defines an error function that measures inconsistency between intended intent labels and observed user behavior, or that measures distances between desired and actual sentiment effects. The server then updates model parameters, such as weights in a neural sentiment classifier or thresholds in rule-based filters, by computing gradients of the error function and applying an optimization algorithm, such as stochastic gradient descent or an adaptive moment method. The server thereby modifies the modules so that, over time, the syntactic parsing becomes more accurate for the types of sentences observed, the semantic intent detection improves, the sentiment estimation better matches actual user reactions, and the prompt sentence is constructed in a way that elicits more effective answers from the generative AI model.
   The server achieves technical improvements in several respects. The server reduces the number of unnecessary tokens passed to the generative AI model by pre-analyzing the question sentence and extracting only relevant semantic attributes and related external information for inclusion in the prompt sentence. This reduction in irrelevant context leads to a shorter prompt, which in turn decreases computational load and latency in the generative AI model. The server also improves answer accuracy by supplying standardized, structured information derived from explicit syntax and semantics, allowing the generative AI model to focus on generation rather than internal inference of user intent and external facts.
   The server further improves data management by maintaining a structured semantic representation and feedback records for each interaction. This representation allows the server to perform targeted updates of submodules without retraining the entire generative AI model. For example, the server can retrain only the sentiment classifier using newly collected feedback data, or adjust only prompt template rules, while keeping the generative AI model parameters fixed. This modular approach increases maintainability and reduces the number of full model retraining cycles, thereby reducing computational cost.
   The server performs processing that is not a mere automation of human tasks but involves specialized computational steps that are specifically adapted to computer architectures. The server uses standardized tokenization and tree-based representations that exploit random access memory addressing patterns and vectorized operations. The server uses neural networks with architectures configured for efficient parallel matrix multiplications on hardware accelerators. The server selects generation parameters and manages prompt length according to memory and time constraints, thereby achieving an efficient utilization of hardware resources that a human could not feasibly reproduce.
   The server also uses rule-based and learned criteria to switch between alternative prompt sentence templates and external data configurations, depending on the intent and emotion state information. The server can, for example, choose a condensed template for high-load conditions to reduce computation, or an extended template including more external data when high precision is required. This capability enables the server to balance response quality and resource consumption dynamically, yielding a technical effect in the form of adaptive computational efficiency.
   In an alternative embodiment, the server uses a different natural language processing library for syntactic and semantic analysis, or uses a custom parser trained on domain-specific data. The server may also use a different sentiment analysis model, such as a transformer-based classifier trained with domain-specific labeled examples. The basic data flow remains the same: the server generates sentence structure information, converts it into semantic representation data, attaches emotion state information and related information, and constructs a controlled prompt sentence.
   In still another embodiment, the server executes the generative AI model locally rather than via an external service. In such a configuration, the server stores the model's weight matrices and configuration files in local nonvolatile storage and loads them into memory for execution on a graphics processing unit or other accelerator unit. The server thereby controls both the pre-processing pipeline and the generation engine within a single computing unit, which allows additional optimizations, such as pruning attention layers or quantizing model parameters to reduce memory usage and improve inference speed.
   In yet another embodiment, the terminal performs partial preprocessing of the question sentence before sending it to the server. For example, the terminal may perform on-device tokenization or input language detection and transmit metadata along with the raw text. The server may then skip certain preprocessing steps or choose a language-specific pipeline. This division of labor between the terminal and the server can further reduce server-side computational load and network traffic.
   Through these various embodiments, the server, the terminal, and the generative AI model cooperate using defined data structures, rule-based prompt sentence construction, and feedback-driven updates to provide improved accuracy, robustness, and efficiency in dialog processing. The system thereby realizes a technical improvement in how computing resources perform natural language dialog, going beyond abstract ideas by specifying concrete data flows, algorithms, and model structures that are tightly integrated with the server hardware and communication network.

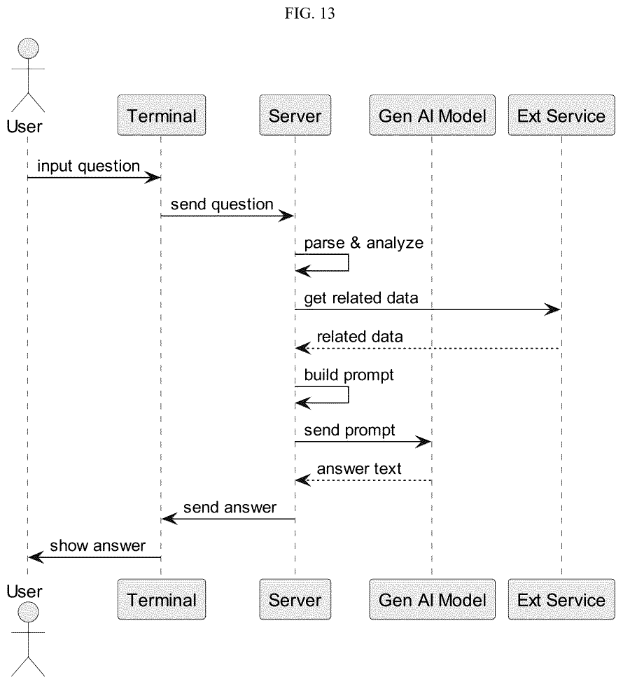

The following describes the processing flow using FIG. 13.

### Step 1:

The user operates the terminal to input a question sentence in a natural language. The terminal displays a text input field and a send control element on a display. The user types, for example, “What will the weather be like today in Tokyo?” into the input field and activates the send control element.
Input: Keystroke events or speech signals from the user.
Output: A question sentence string stored in the terminal memory.
The terminal converts the keystroke events or speech recognition result into a character string, associates a user identifier and a timestamp with the string, and prepares a message object for transmission.

### Step 2:

The terminal transmits the question sentence to the server. The terminal formats the message as a structured request and sends it via a network interface using a communication protocol.
Input: The question sentence string, the user identifier, and the timestamp stored in the terminal.
Output: A network request containing the question data delivered to the server.
The terminal serializes the data into a request payload, attaches protocol headers, and sends the payload over a communication network to an endpoint associated with the server.

### Step 3:

The server receives the request from the terminal and stores the raw question data. The server parses the request payload, extracts the question sentence, the user identifier, and the timestamp, and stores these elements in working memory and optionally in persistent storage.
Input: The network request containing the question data.
Output: A structured record representing the question, stored in server memory or storage.
The server decodes the payload, validates the format, and creates an internal data structure, such as an object or record, that holds the fields needed for subsequent processing.

### Step 4:

The server performs syntactic analysis on the question sentence to generate sentence structure information. The server uses a syntactic analysis module to tokenize the question sentence, assign part-of-speech tags, and determine grammatical dependencies.
Input: The question sentence string from the structured record.
Output: Sentence structure information, represented as a tree or graph with tokens, tags, and relations.
The server invokes a parsing algorithm that converts the sequence of characters into a sequence of tokens, maps each token to a grammatical category, and builds a data structure in which nodes represent tokens and edges represent syntactic relationships.

### Step 5:

The server executes semantic analysis to create semantic representation data. The server uses the sentence structure information to identify key entities and to infer intent information associated with the question.
Input: The sentence structure information generated in Step 4.
Output: Semantic representation data containing at least intent information and parameter fields.
The server traverses the syntactic structure, locates entities such as locations and times, and applies pattern rules or classification logic to determine an intent label, such as a request for specific information. The server then populates a semantic data structure with fields including intent, entities, and parameter values.

### Step 6:

The server performs sentiment analysis to estimate emotion state information of the user. The server processes the question sentence or derived features to infer whether the user's emotional tone is, for example, neutral, positive, or negative.
Input: The question sentence string and optionally the semantic representation data.
Output: Emotion state information associated with the question.
The server converts the text into features, such as sentiment scores or token embeddings, applies a sentiment estimation algorithm, and assigns an emotion label and confidence values.
The server then attaches this emotion state information to the semantic representation data as additional fields.

### Step 7:

The server acquires related information from an external information providing apparatus based on the intent information. The server constructs a query that includes parameters derived from the semantic representation data and sends the query to an external system.
Input: The semantic representation data including intent, entities, and parameters.
Output: Related information obtained from the external information providing apparatus.
The server maps internal parameter names to external query parameters, transmits a request over a network interface, receives a response, and extracts relevant values. The server then integrates these values into the semantic representation as related information fields.

### Step 8:

The server generates a prompt sentence for a generative AI model. The server combines the question sentence, the semantic representation data, the emotion state information, and the related information into a single text block according to a predefined template or rule set.
Input: The question sentence string, the semantic representation data, the emotion state information, and the related information.
Output: A prompt sentence string formatted for input to the generative AI model.
The server selects an appropriate template based on the intent and emotion state, inserts the values of semantic fields and related information into placeholder positions, and concatenates lines or segments into a continuous prompt. For example, the server may generate a prompt sentence such as:
“You are a helpful assistant.
User question: “What will the weather be like today in Tokyo?”

### Analysis:

Intent: request_weather_forecast
Location: Tokyo
Date: today
Sentiment: neutral
   External data:
Condition: sunny
High temperature: 25 degrees Celsius
Low temperature: 18 degrees Celsius

Using the information above, generate a clear and concise answer to the user.”

### Step 9:

The server inputs the prompt sentence to the generative AI model and generates an answer sentence. The server converts the prompt sentence into a token sequence, configures generation parameters, and executes the generative AI model to produce output tokens.
Input: The prompt sentence string created in Step 8.
Output: An answer sentence string generated by the generative AI model.
The server tokenizes the prompt sentence, feeds the token sequence into the generative AI model, iteratively obtains predicted tokens until a termination condition is met, and converts the output token sequence back into a text sequence. The server may perform post-processing, such as trimming or filtering, to finalize the answer sentence.

### Step 10:

The server transmits the generated answer sentence to the terminal. The server prepares a response message including the answer sentence and any additional metadata required by the terminal and sends the message through the network interface.
Input: The answer sentence string produced in Step 9.
Output: A network response containing the answer sentence delivered to the terminal.
The server encapsulates the answer sentence in a response payload, attaches protocol headers, and sends the response over the communication network to the terminal that issued the original request.

### Step 11:

The terminal receives the response from the server and displays the answer sentence to the user. The terminal parses the response payload, extracts the answer sentence, and updates the user interface accordingly.
Input: The network response containing the answer sentence.
Output: A rendered answer sentence on the display of the terminal.
The terminal decodes the payload, retrieves the answer text, inserts the answer into a dialog view, and refreshes the display so that the user can read the answer sentence.

### Step 12:

The server collects feedback-related data for later improvement of processing modules. The server monitors subsequent user behavior, such as whether the user asks a follow-up question or provides explicit feedback, and records such behavior along with the original question, the semantic representation, the prompt sentence, and the answer sentence.
Input: The interaction history including the question, the answer, and user behavior following the answer.
Output: Feedback data stored for use in updating analysis and prompt generation logic.
The server aggregates this data into a structured log, computes performance indicators such as satisfaction proxies or error signals, and stores the results in a database, enabling subsequent learning or adjustment of syntactic analysis, semantic analysis, sentiment analysis, and prompt sentence generation rules.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional dialogue systems and question-answering systems, the computing architecture typically separates (i) natural language understanding, (ii) answer generation, and (iii) user state tracking into loosely coupled or rule-based components. Such architectures suffer from several technical problems in terms of computer technology itself.

First, many existing systems pass only a shallow representation of user input (for example, a short intent label or partial keywords) to a response generation engine. As a result, a generative AI model or template engine operates with limited context, causing repeated round-trips, redundant API calls, and additional heuristic post-processing on the server. This leads to inefficient processor and memory usage, increased network traffic, and higher latency for each interaction.
Second, conventional systems generally do not integrate emotion analysis as a first-class input to the computational pipeline that constructs prompts for a generative AI model. Emotion or sentiment, when present at all, is often handled by a separate post-processing layer that simply appends a fixed phrase, without influencing how the prompt is formulated or how the generative model reasons about the situation. Consequently, the system fails to systematically exploit emotion data to steer the generative AI model, which reduces the effectiveness of a single inference call and may require additional calls or manual intervention to achieve an appropriate tone, thereby degrading throughput and scalability.
Third, typical incentive or benefit mechanisms (for example, discounts, points, or privileges) are implemented as external business logic that is loosely coupled with the dialogue engine. These mechanisms do not use the fine-grained history of question texts and associated emotions stored over time, and they do not feed back into the prompt construction process. As a result, server-side components cannot dynamically adapt prompts or answer policies based on long-term user state, which causes inefficient reuse of historical data, duplicative computations, and sub-optimal personalization from the standpoint of computer resource utilization.
Fourth, existing architectures often treat voice-based interaction as a separate pathway, bolted onto a text-based backend, without unifying the processing pipeline after speech recognition. This dual-path architecture complicates the software stack, increases branching logic in the server, and makes it more difficult to optimize and scale the core processing of natural language data, including preprocessing, emotion analysis, prompt construction, and generative inference.
Accordingly, there is a need for a computing system and processing method that: (i) tightly integrates preprocessing of multi-source textual information and machine-learning analysis models with prompt construction for a generative AI model, (ii) uses real-time emotion analysis results as a structural element of the prompt sentence and of answer adjustment logic, (iii) computes and applies usage benefits in a manner coupled to emotion-aware prompt control, and (iv) unifies text and voice inputs into a single, optimized processing pipeline. Such a system should reduce redundant processing, lower end-to-end latency, improve server-side efficiency in memory and CPU utilization, and increase the technical effectiveness of a single generative AI model inference call.

The specific processing by the specific processing unit 290 of the data processing device 12 in Application Example 2 is realized by the following means.

The present invention provides a server comprising a processor configured to preprocess character information acquired from a plurality of information sources and perform machine learning processing on the preprocessed data to generate an analysis model; analyze a question sentence in a natural language received from a user terminal by performing syntactic analysis and semantic analysis so as to identify a question intention and related items; apply an emotion analysis algorithm to the question sentence to estimate an emotion state included in the question sentence; acquire context information necessary for answer generation from an operational data storage or an external information source based on the question intention and the related items; construct a prompt sentence including the question sentence, the question intention, the context information, and a response policy according to the emotion state, and input the prompt sentence to a generative artificial intelligence model so as to cause the generative artificial intelligence model to generate an answer sentence in a natural language; adjust expression content, apology expression, or explanation amount of the generated answer sentence based on the emotion state and a predefined response rule; calculate a usage benefit comprising discount information, point information, or privilege information based on usage history data of a user and the emotion state, and associate the usage benefit with the answer sentence to generate output information; and transmit the output information to the user terminal so that the user terminal displays the output information as an interactive response, and optionally further configured to process voice-based input by converting an acoustic signal into character string data and to store question sentences and corresponding emotion states in time series and dynamically change instruction content of the prompt sentence, a politeness level of the answer sentence, and a type or an amount of the usage benefit based on the stored result. This enables a unified, emotion-aware prompt-driven dialogue engine in which the server efficiently combines multi-source analysis models, real-time emotion estimation, generative AI model prompting, and incentive control in a single optimized processing pipeline, thereby reducing computational redundancy, lowering interaction latency, improving resource utilization, and technically enhancing the effectiveness and adaptability of automated responses.

The term “processor” refers to a hardware or virtual computation unit, such as a central processing unit or a processing core in a computing apparatus, that executes program instructions to perform the functions described in the claims.

The term “character information” refers to data expressed as symbols of a writing system, including letters, numerals, punctuation, and other textual elements, which are processed as text strings or tokens by the system.
The term “information source” refers to any origin of data from which character information is acquired, including internal data storage, external databases, network services, and content repositories.
The term “preprocess” refers to performing preparatory data processing on raw character information so as to convert the character information into a form suitable for machine learning and natural language processing, including operations such as normalization, tokenization, stop-word removal, and morphological processing.
The term “machine learning processing” refers to computational procedures that use statistical or algorithmic techniques to learn patterns from data, including training or updating models such as classifiers, regressors, or representation learners based on the preprocessed character information.
The term “analysis model” refers to a machine-learned data structure or set of parameters configured to perform analysis tasks, such as intent classification, feature extraction, or sentiment estimation, when applied to input data.
The term “user terminal” refers to a user-operated device having input and output functionality, such as a communication device or a computing device, that transmits question sentences to the server and displays responses from the server.
The term “natural language” refers to a human language used in everyday communication, such as sentences or phrases expressed in a spoken or written form that are processed by natural language processing techniques.
The term “question sentence” refers to a natural language text string input by a user that requests information, assistance, or action from the system.
The term “syntactic analysis” refers to processing that determines structural relationships among words in a sentence, including operations such as part-of-speech tagging and dependency or constituency parsing.
The term “semantic analysis” refers to processing that interprets the meaning of a sentence, including determining concepts, relationships, and roles expressed in the sentence.
The term “question intention” refers to an interpreted purpose or goal underlying a question sentence, such as a request for status information, a complaint, or a query about operational conditions.
The term “related items” refers to information elements associated with a question intention, such as entities, parameters, identifiers, dates, or locations that are extracted from the question sentence or its context.
The term “emotion analysis algorithm” refers to a computational procedure that takes text as input and outputs one or more indicators of emotional state, such as polarity, affect category, or intensity.
The term “emotion state” refers to an estimated psychological condition of a user derived from the user's text, such as satisfaction, dissatisfaction, anger, joy, or neutrality.
The term “context information” refers to supplemental data relevant to answer generation, including operational records, status values, configuration parameters, and external reference data associated with the question intention and the related items.
The term “operational data storage” refers to a data repository that stores operational records, transaction logs, configuration data, or other business-related information used by the system.
The term “external information source” refers to a data provider outside the server's internal storage, such as a remote database, a web service, or another networked system.
The term “prompt sentence” refers to a textual instruction sequence provided as input to a generative artificial intelligence model, the instruction sequence including at least part of a user's question, context information, and a response policy.
The term “response policy” refers to a set of rules, instructions, or style constraints that specify how an answer sentence should be generated, including tone, politeness level, length, and inclusion of certain types of content.
The term “generative artificial intelligence model” refers to a machine learning model configured to generate natural language text as output in response to a given prompt sentence.
The term “answer sentence” refers to a natural language text string generated by the generative artificial intelligence model or by subsequent processing, the text string intended to respond to a user's question.
The term “expression content” refers to lexical choices and phrasing in an answer sentence, including word selection, sentence structure, and style.
The term “apology expression” refers to a text segment in an answer sentence that conveys regret, acknowledgment of inconvenience, or an apology to the user.
The term “explanation amount” refers to a quantitative or qualitative measure of the extent of detail provided in an answer sentence, including the number of explanatory elements or the depth of description.
The term “predefined response rule” refers to a predetermined computational rule or condition that governs how an answer sentence is to be adjusted based on parameters such as emotion state or question category.
The term “usage benefit” refers to a value offered to a user as an incentive, such as a reduction in charge, an allocation of points, or an access privilege, which is computed and associated with the user account or answer sentence.
The term “discount information” refers to data that defines a reduction in a monetary charge or fee to be applied to a user account or transaction.
The term “point information” refers to data that defines a quantity of reward units allocated to a user, the reward units being usable for future transactions or benefits.
The term “privilege information” refers to data that defines an entitlement of a user to receive a special service, access, or condition not available by default.
The term “usage history data” refers to accumulated records of user interactions with the system, including question texts, timestamps, transaction data, and previous benefits.
The term “output information” refers to data prepared for transmission to a user terminal, including an answer sentence, associated usage benefits, and any related metadata.
The term “interactive response” refers to a response presented to a user in a conversational or dialog-like format, wherein successive messages are exchanged between the system and the user.
The term “acoustic signal” refers to a time-varying analog or digital representation of sound captured from a user's voice input by a sensing element of a user terminal.
The term “speech recognition process” refers to processing that converts an acoustic signal of spoken language into a corresponding character string representing the spoken content.
The term “character string data” refers to a sequence of characters forming text that results from conversion of an acoustic signal or from direct text input.
The term “time series” refers to an ordered sequence of data items indexed by time, describing how values such as question sentences and emotion states change across successive interaction events.
The term “prompt control unit” refers to a functional module implemented by the processor that controls construction or modification of prompt sentences to be input to the generative artificial intelligence model, based on stored interaction data.
The term “incentive control unit” refers to a functional module implemented by the processor that determines and adjusts types or amounts of usage benefits based on stored interaction data and emotion states.
The term “politeness level” refers to a parameter or qualitative attribute indicating the degree of formality, courtesy, or respectfulness expressed in an answer sentence.
The term “type of the usage benefit” refers to a category of incentive selected for a user, such as a price reduction, points allocation, or special access.
The term “amount of the usage benefit” refers to a quantitative magnitude of an incentive, such as a discount rate, a number of points, or a duration or extent of a granted privilege.

In one embodiment, a server, a terminal, and a user cooperate to implement the invention.

The server is implemented by one or more computing devices such as physical servers or virtual machines, each including a processor, a memory, a network interface, and a non-volatile storage. The server executes an operating system and application software implemented, for example, in a high-level programming language. The memory stores modules for text preprocessing, machine learning analysis, emotion estimation, prompt sentence construction, generative AI model interfacing, answer adjustment, and incentive computation.
The terminal is implemented by a communication device or a computing device such as a smartphone, a tablet, or a personal computer. The terminal includes an input interface such as a touch screen, a keyboard, or a microphone, and an output interface such as a display and a speaker. The terminal executes an application program that communicates with the server over a communication network using a standard communication protocol. The terminal application is implemented, for example, using a cross-platform user interface framework, and provides a conversational interface through which the user inputs question sentences and views returned responses.
The user operates the terminal to input question sentences in a natural language. The user may input the question sentences as text via a keyboard or as speech via a microphone. When the user provides speech, the terminal converts an acoustic signal into character string data by invoking a speech recognition module. The speech recognition module applies signal processing and acoustic modeling to convert the time-series acoustic signal into a sequence of phonetic units, and further into a sequence of characters, thereby generating character string data equivalent to a typed question sentence.
The server stores, in the non-volatile storage, character information acquired from a plurality of information sources. Such information sources include, but are not limited to, internal operational data storages, external databases, networked information services, and content repositories. The character information includes text records of transactions, configuration data, historical question-answer pairs, and other domain-specific textual content.
The server preprocesses the character information by executing a preprocessing module. The preprocessing module performs normalization, tokenization, and filtering of the text. For example, the server converts all characters to a unified case, removes markup and control symbols, splits sentences into tokens using a dictionary or a statistical tokenizer, and removes high-frequency stop words that are not useful for downstream machine learning processing. The server also performs morphological analysis such as stemming or lemmatization to map inflected word forms to base forms. The preprocessed character information is stored in an internal data structure such as a token table or a sparse representation suitable for vectorization.
The server executes a machine learning module that consumes the preprocessed character information to generate one or more analysis models. In one embodiment, the server constructs a neural network model for intent classification and a neural network model for emotion estimation. The server represents each token sequence as a numerical vector using techniques such as word embeddings or contextual embeddings. The server then inputs these vectors into a neural network architecture implemented, for example, as a multi-layer perceptron, a convolutional neural network, or a transformer encoder. The neural network includes parameters (weights and biases) initialized according to a distribution and updated during training.
The server trains each analysis model by minimizing an error function, such as cross-entropy loss for classification. The server uses mini-batch gradient descent or a variant thereof to compute gradients of the loss function with respect to parameters of the neural network and updates the parameters according to an optimization algorithm such as stochastic gradient descent, Adam, or RMSProp. The server may augment training data by applying textual data augmentation methods such as synonym replacement, word dropout, or paraphrase generation, thereby improving robustness of the analysis models. By executing these steps, the server generates an analysis model that efficiently maps input text to intents, entities, and emotion states, with reduced inference latency and improved classification accuracy compared to purely rule-based systems.
When the terminal sends a question sentence to the server, the server first applies the same preprocessing pipeline to the incoming question sentence. The server then inputs the preprocessed tokens into the analysis model stored in the memory. The intent classification model outputs a probability distribution over a set of intent categories. The server selects a question intention by choosing the category with the highest probability. The server also extracts related items, such as entity references, identifiers, dates, and locations, using a sequence-labeling component (for example, a conditional random field layer or a token-level classifier) integrated into the neural architecture. By structuring the analysis in this way, the server avoids repeated ad-hoc pattern matching and minimizes computational branching, thereby improving throughput.
The server simultaneously applies an emotion analysis algorithm to the question sentence. In one embodiment, the server uses a neural sentiment classifier trained on labeled emotion data. The classifier receives an embedding vector of the question sentence and outputs scores corresponding to emotion states such as satisfaction, dissatisfaction, anger, joy, or neutrality. The server converts the scores into an emotion state by selecting a dominant label or by applying thresholding. The server stores, in association with the question sentence, the question intention, related items, and the emotion state in a time-series interaction log. This log is stored in a structured data storage to allow efficient retrieval and aggregation.
The server acquires context information necessary for answer generation by querying an operational data storage or external information source. For example, if the question intention is a delivery status inquiry, the server retrieves order records, shipping statuses, and estimated delivery times from a transaction database. If the question intention is an inventory inquiry, the server retrieves stock levels and availability information. These records are obtained by executing structured queries optimized for indexing schemes of the underlying storage, reducing disk I/O and query latency.
The server constructs a prompt sentence for a generative AI model by combining the question sentence, the question intention, the context information, and a response policy according to the emotion state. The server maintains a template or a rule set that specifies which parts of the context and which style constraints should be included for each combination of intention and emotion. Unlike a simple forwarding of text, the server explicitly encodes structural and emotional information in the prompt sentence, which allows the generative AI model to produce a context-appropriate answer in a single inference.
For example, the server may construct the following prompt sentence for a neutral delivery status inquiry:
“User question: ‘Please tell me the delivery status of the ordered product.’
Order information: the order is currently in transit and the expected delivery date is two days from now.
Generate a clear, concise, and polite answer in English that explains the current delivery status and the expected delivery date.”
For a complaint indicating dissatisfaction, the server may construct:
“The user says: ‘This service is terrible.’
Detected emotion: dissatisfaction.
Generate an empathetic and apologetic response in English.
Acknowledge the complaint, apologize sincerely, and invite the user to explain the problem in more detail.”
The server inputs the prompt sentence into a generative AI model, which is implemented as a sequence-to-sequence neural network or a transformer-based language model. The generative AI model comprises multiple layers of attention mechanisms, feed-forward networks, and normalization components. The model receives the prompt sentence as a sequence of tokens, converts it into embedded vectors, and propagates them through the layers to compute a probability distribution over output tokens at each generation step. The server configures parameters of the generation process, such as maximum output length, temperature, and sampling strategy (for example, greedy decoding, beam search, or nucleus sampling), to balance between determinism and diversity of responses.
The server receives an answer sentence generated by the generative AI model. The answer sentence is represented as a sequence of tokens decoded into characters. The server then adjusts expression content, apology expression, and explanation amount of the answer sentence based on the emotion state and predefined response rules. For example, when the emotion state indicates dissatisfaction or anger, the server checks whether the answer sentence contains an apology phrase. If an apology phrase is missing, the server inserts or prepends a predefined apology segment. When the emotion state indicates neutrality, the server may remove excessive politeness expressions to shorten the answer, thereby reducing display load and cognitive load on the user.
The server calculates a usage benefit for the user based on usage history data and the emotion state. The server maintains, in the operational data storage, records of user interactions, including counts of negative episodes, frequency of access, and accumulated points. A benefit computation module applies a function that takes the emotion state, the number of recent interactions, and existing benefits as inputs. The function outputs discount information, point information, or privilege information designed to compensate for dissatisfaction or to reward frequent use. Because the computation uses structured interaction history and emotion state as numerical inputs, the server can compute the usage benefit automatically and consistently without manual intervention.
The server associates the usage benefit with the answer sentence to generate output information. The output information is structured as a composite data object comprising the adjusted answer sentence, usage benefit descriptors, and metadata for the terminal. The server transmits the output information to the terminal through the network interface. The terminal receives the output information, decodes it, and renders the answer sentence as an interactive response in the conversational interface. If the output information includes a usage benefit, the terminal also displays an indication such as “A discount has been applied to your next fee” or “Additional points have been added to your account.”
In an additional embodiment, the server processes voice-based input in a unified manner. The terminal converts the acoustic signal into character string data and transmits the character string data to the same pipeline used for textual input. Because the server does not branch into a separate logic for voice queries after the conversion, the same preprocessing, analysis model, emotion estimation, prompt construction, generation, and benefit computation steps are reused. This unified design reduces code duplication, simplifies optimization, and enables shared caching of intermediate representations across different input modalities, thereby improving processing speed and reducing memory usage.
In another embodiment, the server stores question sentences and corresponding emotion states in a time series and uses this stored result to dynamically change instruction content of the prompt sentence, a politeness level of the answer sentence, and a type or an amount of the usage benefit. The server implements a prompt control unit that reads historical emotion patterns for a given user and modifies the prompt sentence by, for example, requesting the generative AI model to provide more detailed explanations when past interactions indicate confusion, or to provide shorter, direct answers when the user has previously reacted negatively to long responses. This data-driven adaptation of prompts improves the effectiveness of each generative inference call and reduces the need for follow-up queries, thereby lowering communication load and server processing cycles per resolved issue.
The server further implements an incentive control unit that adjusts types and amounts of usage benefits based on the time-series emotion record. For example, if the record shows consecutive dissatisfied states, the server increases the magnitude of a discount or offers a higher tier privilege. Because the incentive control is implemented as an algorithm operating on stored interaction vectors, rather than manual adjustment, the server can respond in real time at scale, while reusing computed features and avoiding repetitive retrieval of raw logs. From a computer technology standpoint, this configuration improves processing efficiency and technical performance in several ways. By integrating intent classification, entity extraction, and emotion estimation into a compact analysis model and using the output structurally in a prompt sentence, the server reduces redundant transformations and avoids multiple separate invocations of generative logic. A single, well-formed prompt sentence enables the generative AI model to produce a context-appropriate answer in one pass, which reduces the number of network round-trips and model evaluations. This leads to lower latency and reduced energy consumption on the server hardware.
The server uses specific data structures for tokens, embeddings, and interaction logs that facilitate batch processing and caching, thereby increasing throughput. The server also uses predefined response rules to adjust generated text without requiring additional model calls, which decreases computational load and increases robustness. The emotion-aware and history-aware prompt construction is not a simple automation of human judgment, but a technical mechanism by which the server encodes multi-dimensional state into a textual instruction in a way that is optimized for the internal operation of a transformer-based generative model. This non-conventional integration of historical emotion vectors into prompt sentences allows the system to achieve higher answer relevance and fewer corrective exchanges than a naive generative system that ignores structured history.
In alternative embodiments, the server may replace or augment the neural intent classifier with a hybrid model that combines a recurrent neural network with a rule-based pattern matcher, or may use different loss functions such as focal loss to handle imbalanced emotion classes. The generative AI model may have different architectures, including encoder-decoder configurations or decoder-only configurations with varying depth and width.
The server may also adjust hyperparameters dynamically based on system load, such that temperature and beam width are reduced under heavy load to decrease computation time.
In all embodiments, the server, the terminal, and the user interact through a concrete computing infrastructure that executes specific data transformations, model inferences, and rule-based adjustments. By specifying the structure of analysis models, prompt sentences, and incentive computations, and by tying them tightly to the configuration and operation of the generative AI model, the invention provides an improvement to computer technology itself, including faster and more accurate dialogue processing, reduced communication overhead, more efficient use of memory and CPU resources, and a more effective single-pass utilization of a generative AI model.

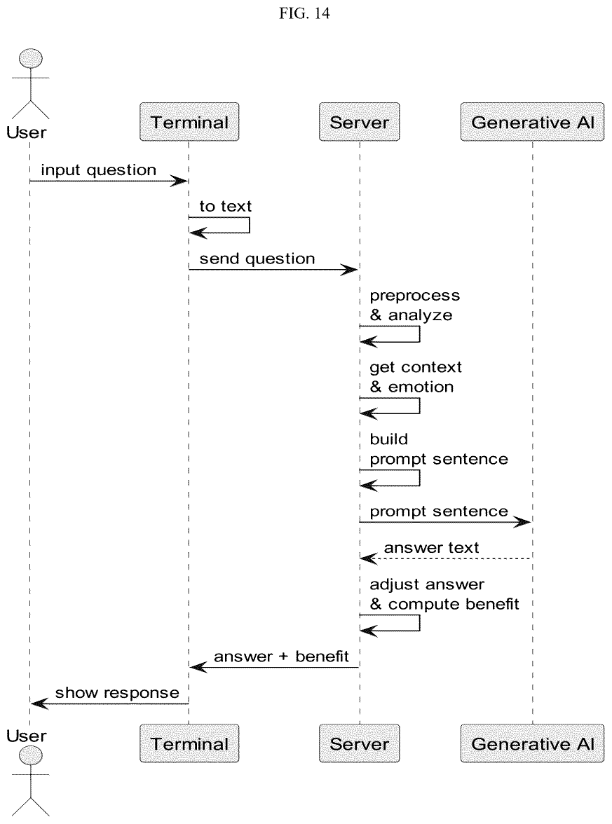

The following describes the processing flow using FIG. 14.

### Step 1:

The user operates the terminal to start a conversation and input a question.
Input: The user's intention to ask a question; raw user interaction (tap, click, or voice start).
Output: A raw question input (text characters or an acoustic signal) held in the terminal.
The user taps a chatbot icon or opens a support screen on the terminal and then either types a question in a text field or presses a microphone button and speaks. The terminal captures the keystrokes as a character string or records the spoken voice as an acoustic signal in digital form (for example, a sampled audio buffer).

### Step 2:

The terminal converts the user's input into a normalized text string and prepares it for transmission.
Input: Raw text characters or an acoustic signal from Step 1.
Output: A normalized text question and a request payload ready for network transmission.
If the user typed text, the terminal trims whitespace, ensures a consistent character encoding, and stores the text such as “Please tell me the delivery status of the ordered product.”
If the user spoke, the terminal sends the acoustic signal to a speech recognition module, receives the recognized character string, and stores it as the question text. The terminal then creates a data object including user identifier, the question text, timestamp, and optional recent dialogue context.

### Step 3:

The terminal sends the question payload to the server over the network.
Input: The request payload generated in Step 2.
Output: A network request (for example, an HTTP message) containing the payload delivered to the server.
The terminal opens a communication channel (for example, HTTPS) to a server endpoint, serializes the payload into a structured format, and transmits it. The terminal starts a timer and shows a “processing” indicator to the user while waiting for a response.

### Step 4:

The server receives the question payload and logs the interaction metadata.
Input: The network request from Step 3.
Output: Parsed question text and associated metadata stored in server memory and logs.
The server's network interface accepts the incoming request, and a server application parses the payload to extract the question text, the user identifier, the timestamp, and the context. The server writes these values into a log structure and may insert a record into a database table for later analysis, thereby converting the raw request into internal data objects for further processing.

### Step 5:

The server preprocesses the question text using natural language preprocessing operations.
Input: Raw question text from Step 4.
Output: A tokenized and normalized representation of the question suitable for model input.
The server applies text normalization (lowercasing, removal of control characters), then performs tokenization to split the text into word units. The server optionally removes stop words and performs stemming or lemmatization, converting words to canonical forms. The server packs the resulting tokens into a vector or sequence representation that matches the input format required by downstream machine learning models.

### Step 6:

The server analyzes the question to determine a question intention and related items.
Input: The token sequence and normalized text from Step 5.
Output: A structured representation including a question intention label and a set of related items.
The server feeds the token sequence into an intent classification model and computes a probability distribution over predefined categories (for example, delivery status inquiry, inventory inquiry, business hours inquiry, payment issue). Based on the highest probability, the server selects a question intention. In parallel, the server runs an entity extraction component over the token sequence to identify related items such as product names, order IDs, dates, and locations. The server assembles these results into a structured object that explicitly encodes what the user is asking and which parameters are present.

### Step 7:

The server performs emotion analysis on the question text to estimate an emotion state.
Input: The original or normalized question text from Step 5.
Output: An emotion state label and corresponding scores associated with the question.
The server inputs the question text or its embedding into an emotion analysis algorithm, which computes numeric scores for different emotion categories such as positive, negative, dissatisfaction, anger, or neutral. The server compares these scores and selects one or more labels (for example, “neutral” or “dissatisfaction”). The server attaches the selected emotion state and scores to the structured representation of the question, thereby augmenting the internal state with emotional information.

### Step 8:

The server retrieves context information from internal or external data storages based on the question intention and related items.
Input: The question intention and related items from Step 6.
Output: Context information records relevant to answering the question.
The server analyzes the intention (for example, “delivery status inquiry”) and uses the related items (for example, an order ID) to construct a query for an operational data storage or an external service. The server executes the query (for example, a database query or an API call) and retrieves records such as current delivery status, expected delivery date, inventory level, or business hours. The server then formats these records into a structured context object that can be easily referenced in later steps.

### Step 9:

The server constructs a prompt sentence for a generative AI model using the analyzed data.
Input: The question text, question intention, related items, context information, and emotion state from Steps 5-8.
Output: A prompt sentence that encodes instructions and context for the generative AI model.
The server selects a template or rule set based on the combination of question intention and emotion state. The server fills the template with the question text and the retrieved context information, and appends explicit instructions that define the desired answer style (for example, polite, concise, apologetic). The resulting prompt sentence may be, for example: “User question: ‘Please tell me the delivery status of the ordered product.’
Order information: the order is currently in transit and the expected delivery date is two days from now.
Generate a clear, concise, and polite answer in English that explains the current delivery status and the expected delivery date.”
or, for a complaint:
“The user says: ‘This service is terrible.’
Detected emotion: dissatisfaction.
Generate an empathetic and apologetic response in English.
Acknowledge the complaint, apologize sincerely, and invite the user to explain the problem in more detail.”
By assembling these parts into a single text, the server transforms multiple structured inputs into a unified prompt sentence suitable for the generative AI model.

### Step 10:

The server inputs the prompt sentence into a generative AI model and generates an answer sentence.
Input: The prompt sentence from Step 9.
Output: A raw generated answer sentence in natural language text.
The server sends the prompt sentence to the generative AI model, which is hosted either locally or as a remote service. The server sets generation parameters (for example, maximum token count, temperature, and sampling strategy), and then invokes the model. The generative AI model processes the prompt sentence, computes probabilities over candidate next tokens, and sequentially outputs tokens that form an answer sentence. The server receives these tokens, decodes them back into text, and stores the generated answer sentence as a string.

### Step 11:

The server adjusts the generated answer sentence based on the emotion state and predefined response rules.
Input: The generated answer sentence from Step 10 and the emotion state from Step 7.
Output: An adjusted answer sentence with modified expression content, apology expression, or explanation amount.
The server evaluates the emotion state (for example, neutral, dissatisfaction, anger) and consults a rule set that defines how answers should be modified for each state. If the emotion state indicates dissatisfaction, the server checks the content of the answer sentence for apology phrases; if they are missing or insufficient, the server prepends or inserts apology expressions and possibly adds more explanation. If the emotion state is neutral, the server may remove redundant polite phrases to shorten the text. The server thus transforms the raw generated text into an adjusted answer that better matches the user's emotional context.

### Step 12:

The server computes a usage benefit for the user and associates it with the adjusted answer sentence.

Input: The user identifier and time-series usage history, together with the emotion state from Step 7.
Output: Usage benefit information (for example, discount, points, privilege) linked to the current answer.
The server retrieves the usage history for the user, including counts of prior interactions, recorded emotion states, and existing benefits. Using these data as inputs, the server applies a benefit calculation function to decide whether to grant a discount, points, or a privilege and in what amount. The server then generates a textual description of the benefit, such as “A 10% discount has been applied to your next monthly fee” or “500 bonus points have been added to your account,” and links this description to the adjusted answer sentence. The combined result becomes part of the output information.

### Step 13:

The server assembles the output information and transmits it to the terminal.
Input: The adjusted answer sentence from Step 11 and the usage benefit information from Step 12.
Output: A response payload containing the answer and associated benefit information delivered to the terminal.
The server creates a response structure that includes the final answer text, any benefit descriptions, and optional metadata such as emotion label and timestamps. The server serializes this structure into a format suitable for network transmission and sends it back to the terminal using the existing communication channel. The server may also record the final output content into a log or database for future analysis and model improvement.

### Step 14:

The terminal receives the response payload and displays the interactive response to the user.
Input: The response payload from Step 13.
Output: A rendered conversational message and, if applicable, a visible benefit indication on the terminal display.
The terminal parses the received payload, extracts the answer text and benefit information, and removes the “processing” indicator started earlier. The terminal updates its user interface by appending a new message bubble showing the answer text. If benefit information is present, the terminal displays a separate element (for example, “You have received a discount” or “New points have been added”). The terminal then waits for further user input.

### Step 15:

The user reads the displayed response and decides whether to continue the interaction.
Input: The displayed answer and benefit information from Step 14.
Output: A new user action, such as closing the conversation or providing a follow-up question.
The user views the answer sentence and any benefit notification. If the user is satisfied, the user may simply terminate the session. If the user requires more information or clarification, the user inputs a follow-up question on the terminal, which becomes a new question text or acoustic signal and re-enters the processing flow starting at Step 1 or Step 2.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

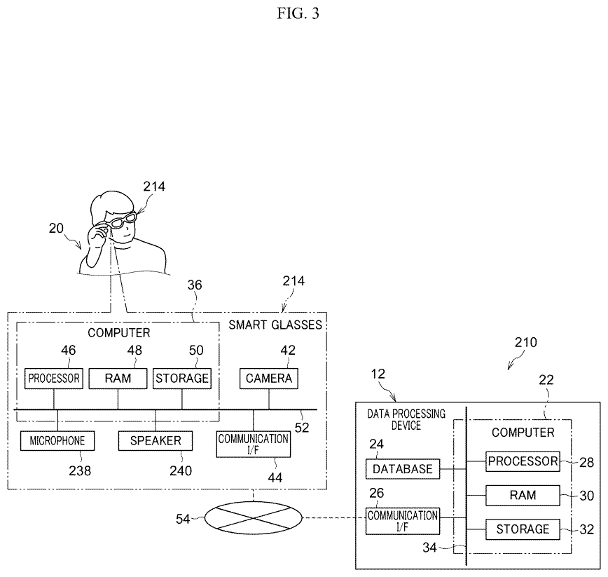

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

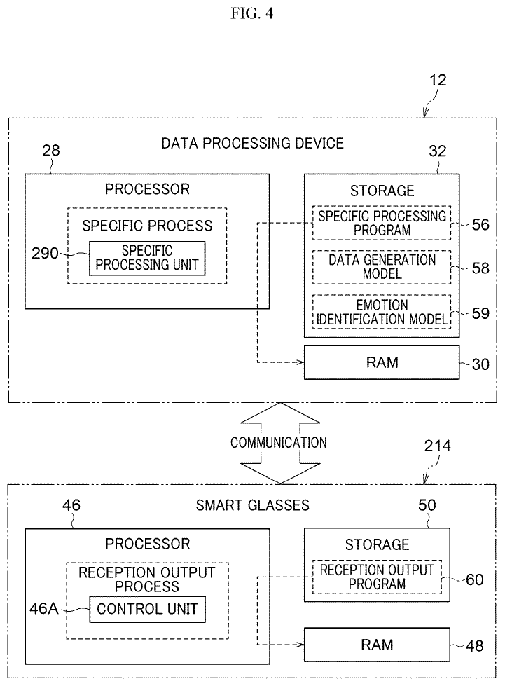

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

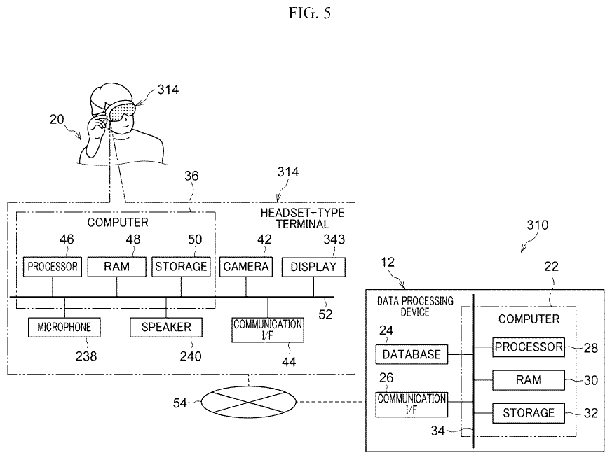

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

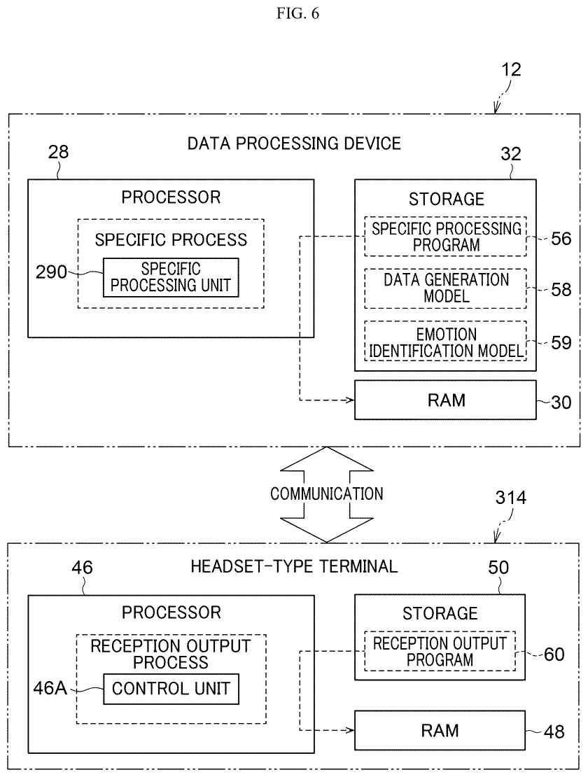

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

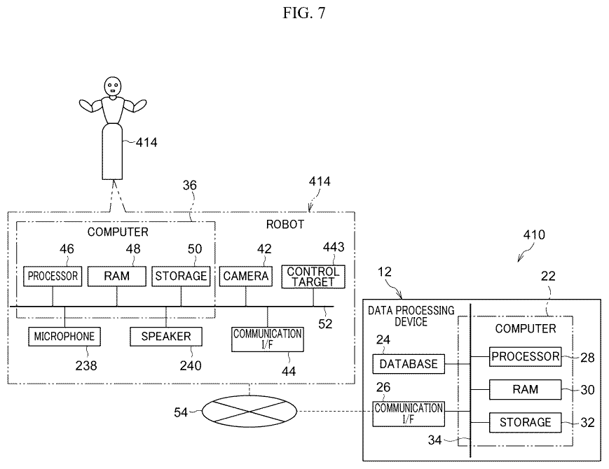

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

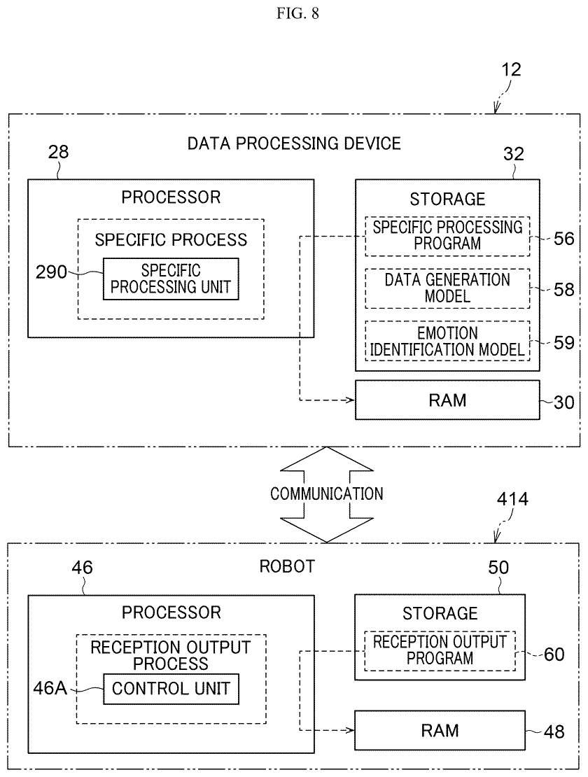

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

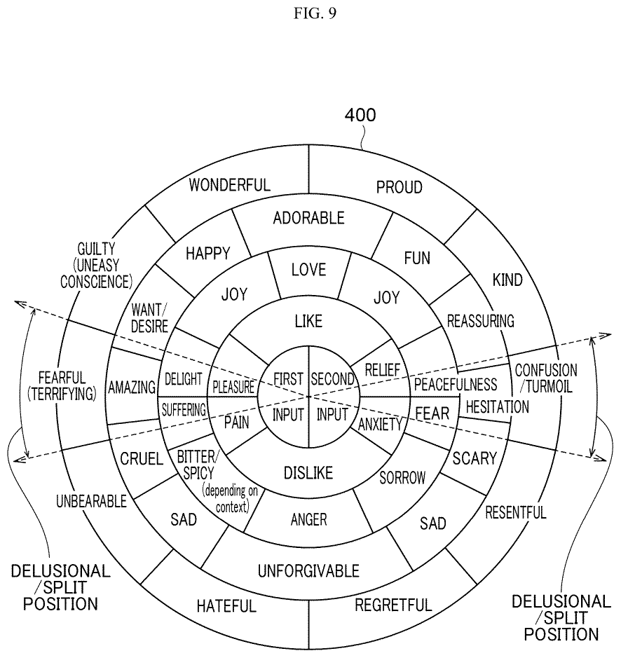

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

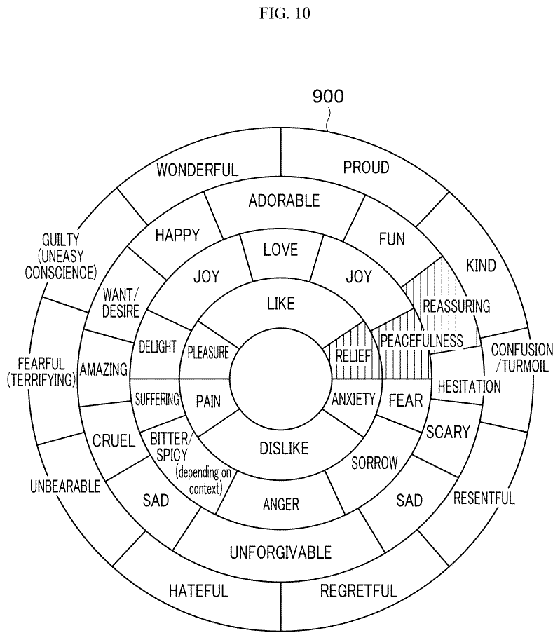

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive character information obtained from a plurality of information sources, and perform
preprocessing on the character information by normalizing character types and removing unnecessary symbols and numerals,
segment the preprocessed character information into lexical units, perform decomposition processing including removal of function words and conversion of the lexical units into stems, and convert the lexical units into numerical representations based on statistical feature quantities,
generate a classification estimation model using a supervised learning scheme based on the numerical representations and associated classification information, and estimate classification information for new character information corresponding to the numerical representations,
construct an instruction sentence to be input to a generative information processing model based on a question sentence received from a user and the classification information, input the instruction sentence to the generative information processing model, and cause the generative information processing model to generate a response sentence,
analyze character input received from the user by using an emotion estimation scheme to estimate an emotional state, and adjust expression content of the response sentence according to the emotional state, and
collect usage history information of the user, and update the classification estimation model and a method for constructing the instruction sentence for the generative information processing model based on the usage history information and the emotional state.

### (Supplementary 2)

The system according to supplementary 1,
wherein the processor is configured to
cause at least a part of the preprocessing of the character information, the decomposition processing into lexical units, and the conversion processing into the numerical representations to be executed by an information processing terminal on a user side, and cause generation of the classification estimation model and generation of the response sentence by the generative information processing model to be executed by an information processing apparatus connected via a communication network.

### (Supplementary 3)

The system according to supplementary 1,
wherein the processor is configured to
dynamically change at least one of an output format, a level of detail, and a tone in the instruction sentence input to the generative information processing model based on both the classification information estimated by the classification estimation model and the emotional state.

### Application Example 1

### (Supplementary 1)

A system comprising a processor,
wherein the processor is configured to
acquire character-based information from a plurality of information sources, perform preprocessing on the character-based information by executing at least one of cleaning, word segmentation, function word removal, stemming, and lemmatization, and convert the preprocessed character-based information into features to generate machine-learning data; and
construct a learned model representing a user's interest on the basis of the machine-learning data and user behavior information, calculate a relevance index for new character-based information by using the learned model, and generate an optimized information set for each user by ranking the character-based information for the user in accordance with the relevance index; and
construct a prompt sentence to be input to a generative AI model on the basis of the optimized information set and user interest information, input the prompt sentence and the optimized information set to the generative AI model, acquire summary information or explanatory information from the generative AI model, and add the summary information or the explanatory information to the optimized information set to constitute presentation information for the user; and
acquire, as behavior history, at least one of browsing history, operation history, and evaluation information with respect to the presentation information transmitted from a user terminal, and perform relearning or updating of the learned model on the basis of the behavior history so as to continuously adjust the learned model and contents of the prompt sentence; and
analyze a user's character input by using an affective analysis algorithm to estimate an emotional state of the user, and adjust at least one of expression content and presentation manner of response information obtained from the generative AI model on the basis of the emotional state and the response information; and
transmit the ranked information set and the summary information or the explanatory information from the generative AI model to the user terminal via a communication path, and provide the presentation information in a displayable format on the user terminal.

### (Supplementary 2)

The system according to supplementary 1,
wherein the processor is configured to cause the user terminal to display the presentation information, detect at least one of selection operation, viewing time, evaluation input, and feedback input performed by the user with respect to the presentation information, and cause the user terminal to transmit a detection result to the system as the behavior history, thereby adaptively optimizing, on a per-user basis, the learned model and a structure of the prompt sentence for the generative AI model.

### (Supplementary 3)

The system according to supplementary 1,
wherein the processor is configured to track the emotional state of the user over time, analyze a combination of the emotional state and the behavior history with respect to the presentation information, and dynamically change at least one of instruction content in the prompt sentence, an output control condition of the generative AI model, and an amount or type of information to be provided to the user.

### Example 2

### (Supplementary 1)

A system comprising a processor,
wherein the processor is configured to
receive, from a user terminal, a question sentence expressed in a natural language, and perform syntactic analysis processing on the question sentence to generate sentence structure information,
perform semantic analysis processing based on the sentence structure information to extract lexical meaning information and intent information of the question, and generate semantic representation data including the intent information of the question,
perform sentiment analysis processing on the question sentence to estimate emotion state information of a user, and add the emotion state information to the semantic representation data,
acquire related information from an external information providing apparatus based on the intent information included in the semantic representation data, and add the related information to the semantic representation data,
generate a prompt sentence to be input to a generative model based on the question sentence, the semantic representation data, the emotion state information, and the related information, and input the prompt sentence to the generative model so as to cause the generative model to generate an answer sentence expressed in a natural language, and transmit the generated answer sentence to the user terminal.

### (Supplementary 2)

The system according to supplementary 1,
wherein the processor is configured to
collect usage history information of the user and response information to the answer sentence, and update at least part of the syntactic analysis processing, the semantic analysis processing, the sentiment analysis processing, or processing for generating the prompt sentence, by using the usage history information and the response information as feedback data.

### (Supplementary 3)

The system according to supplementary 1,
wherein the processor is configured to
dynamically change expression policy information or output condition information included in the prompt sentence according to the emotion state information, and thereby adjust at least one of a style, a length, or content of the answer sentence output from the generative model.

### Application Example 2

### (Supplementary 1)

A system comprising a processor,
wherein the processor is configured to
preprocess character information acquired from a plurality of information sources and perform machine learning processing on the preprocessed data to generate an analysis model, and
analyze a question sentence in a natural language received from a user terminal by performing syntactic analysis and semantic analysis so as to identify a question intention and related items, and
apply an emotion analysis algorithm to the question sentence to estimate an emotion state included in the question sentence, and
acquire context information necessary for answer generation from an operational data storage or an external information source based on the question intention and the related items, and construct a prompt sentence including the question sentence, the question intention, the context information, and a response policy according to the emotion state, and input the prompt sentence to a generative artificial intelligence model so as to cause the generative artificial intelligence model to generate an answer sentence in a natural language, and adjust expression content, apology expression, or explanation amount of the generated answer sentence based on the emotion state and a predefined response rule, and calculate a usage benefit comprising discount information, point information, or privilege information based on usage history data of a user and the emotion state, and associate the usage benefit with the answer sentence to generate output information, and transmit the output information to the user terminal so that the user terminal displays the output information as an interactive response.

### (Supplementary 2)

The system according to supplementary 1,
wherein the processor is configured to
control execution of a voice-based interaction by causing a terminal device of the user to acquire an acoustic signal from a voice input, convert the acoustic signal into character string data by a speech recognition process, and transmit the character string data to the system of supplementary 1 so that the processes of supplementary 1 are performed based on the character string data.

### (Supplementary 3)

The system according to supplementary 1,
wherein the processor is configured to store, in time series, each question sentence transmitted from the user terminal and the emotion state corresponding to each question sentence, and based on a storage result, dynamically change instruction content of the prompt sentence to be input to the generative artificial intelligence model, a politeness level of the answer sentence, and a type or an amount of the usage benefit, so as to function as a prompt control unit and an incentive control unit.

What is claimed is:

1. A system comprising:
circuitry configured to:
receive, via a communication interface coupled to a packet-switched network, character information from a plurality of information sources, apply preprocessing including character normalization and removal of unnecessary symbols, segment the preprocessed character information into lexical units, and convert the lexical units into numerical representations;
analyze a query received from a terminal device via the communication interface using a natural language processing technique, generate a prompt sentence incorporating the analyzed query and the preprocessed character information, and input the prompt sentence to a generative AI model to generate an answer; and
analyze text input of the user using a sentiment analysis algorithm to estimate an emotional state, adjust the generated answer based on the estimated emotional state, and transmit the adjusted answer to the terminal device via the communication interface.

2. The system according to claim 1, wherein the circuitry is configured to receive character information from a plurality of information sources via the communication interface, apply preprocessing including character normalization, removal of unnecessary symbols and numerals, and segmentation into lexical units, and convert the lexical units into numerical representations for storage in a storage device.

3. The system according to claim 2, wherein the circuitry is configured to perform decomposition of the lexical units including removal of function words and conversion to stems, and apply a vector embedding algorithm to convert the decomposed lexical units into numerical vectors stored in the storage device.

4. The system according to claim 3, wherein the circuitry is configured to apply a machine learning algorithm to the numerical vectors to analyze patterns in the preprocessed character information, and generate a structured knowledge representation for use in prompt sentence generation.

5. The system according to claim 4, wherein the circuitry is configured to receive a query from the terminal device via the communication interface, apply natural language processing to analyze the query to identify intent and relevant entities, and retrieve relevant entries from the structured knowledge representation.

6. The system according to claim 5, wherein the circuitry is configured to generate the prompt sentence incorporating the analyzed query, the relevant entries from the structured knowledge representation, and an instruction for the generative AI model to generate an answer, and input the prompt sentence to the generative AI model.

7. The system according to claim 1, wherein the circuitry is configured to apply a sentiment analysis algorithm to text input received from the terminal device to estimate the emotional state of the user, classify the estimated emotional state into a plurality of categories, and select an answer adjustment strategy based on the classified emotional state.

8. The system according to claim 7, wherein the circuitry is configured to adjust at least one of a tone, a content depth, and a presentation format of the generated answer based on the selected answer adjustment strategy.

9. The system according to claim 1, wherein the circuitry is configured to collect usage data of the user from the terminal device via the communication interface, update the structured knowledge representation through a feedback loop incorporating the usage data, and regenerate numerical representations based on the updated knowledge representation.

10. The system according to claim 9, wherein the circuitry is configured to monitor an emotional state of the user in real time based on text input received from the terminal device, and dynamically adjust the content or amount of usage-related information incorporated into the generated answer.

11. The system according to claim 1, wherein the circuitry is configured to receive character information from a first information source and a second information source via the communication interface, independently preprocess the character information from each source, and merge the preprocessed information into a unified knowledge representation in the storage device.

12. The system according to claim 11, wherein the circuitry is configured to detect conflicts between information from different sources in the unified knowledge representation, and generate a prompt sentence for the generative AI model to resolve the conflicts and produce a consistent answer.

13. The system according to claim 1, wherein the circuitry is configured to maintain session context data in the storage device across multiple queries received from the terminal device within a session, incorporate the session context data into the prompt sentence for the generative AI model, and generate contextually consistent answers.

14. The system according to claim 13, wherein the circuitry is configured to detect a topic transition between successive queries based on the analyzed query intent, update the session context data to reflect the transition, and adjust the prompt sentence accordingly.

15. The system according to claim 1, wherein the circuitry is configured to periodically update the character information stored in the storage device by acquiring new information from the plurality of information sources via the communication interface, reprocess the updated information, and regenerate numerical representations.

16. The system according to claim 15, wherein the circuitry is configured to detect changes in the updated character information that exceed a significance threshold, trigger retraining of the machine learning model using the updated numerical representations, and update the structured knowledge representation accordingly.

17. The system according to claim 1, wherein the circuitry is configured to generate a confidence score for the generated answer based on the relevance of the retrieved entries from the structured knowledge representation, and present the confidence score to the terminal device along with the answer.

18. A system comprising:
circuitry configured to:
receive, via a communication interface coupled to a packet-switched network, character information from a plurality of information sources, apply preprocessing and convert to numerical representations, and store the numerical representations in a storage device;
analyze a query from a terminal device using natural language processing, generate a prompt sentence incorporating the query and the numerical representations, input the prompt sentence to a generative AI model, and obtain an answer;
apply a sentiment analysis algorithm to text input from the terminal device to estimate an emotional state, and adjust the answer based on the estimated emotional state; and
transmit the adjusted answer to the terminal device via the communication interface, and update the storage device through a feedback loop incorporating usage data.

19. The system according to claim 18, wherein the circuitry is configured to monitor the emotional state of the user in real time based on text input received from the terminal device, and dynamically adjust the content or presentation of the answer based on changes in the monitored emotional state.

20. A method comprising:
receiving, via a communication interface coupled to a packet-switched network, character information from a plurality of information sources, applying preprocessing to generate numerical representations, and storing the numerical representations in a storage device;
analyzing a query received from a terminal device via the communication interface using a natural language processing technique, generating a prompt sentence incorporating the analyzed query and the numerical representations, and inputting the prompt sentence to a generative AI model to generate an answer; and
analyzing text input of the user using a sentiment analysis algorithm to estimate an emotional state, adjusting the generated answer based on the estimated emotional state, and transmitting the adjusted answer to the terminal device via the communication interface.
